(19) United States
(12) Patent Application Publication
(10) Pub. No.: US 2011/0178828 A1
(43) Pub. Date: Jul. 21, 2011

(54) SALE DECISION METHOD AND SALE REQUEST EVALUATION METHOD

(75) Inventors: Yi-Feng HUNG, Hsinchu City (TW); Chien-Hao CHEN, Taipei City (TW)

(73) Assignee: National Tsing Hua University, Hsinchu (TW)

(21) Appl. No.: 12/834,251

(22) Filed: Jul. 12, 2010

(30) Foreign Application Priority Data
Jan. 15, 2010 (TW) 099101040

(51) Int. Cl. G06Q 10/00; G06N 5/02

(52) U.S. Cl. 705/5; 706/52

(57) ABSTRACT

A sale decision method and a sale request evaluation method are disclosed to increase the revenue by selling available products. The sale decision method is applied in a sale decision system that includes an input module, a database module, a decision computation module, and an output module. The sale decision method comprises a sale request receiving process, a sale decision making process, and a sale decision output process. The input module receives a sale request, the decision computation module produces a sale decision, and the output module outputs the sale decision. In addition, the sale request evaluation method is applied in a sale request evaluation system that includes an input module, a database module, a sale request evaluation module, and an output module to determine the quotation of price for a sale request.

### BACKGROUND OF THE INVENTION

1. Field of the Invention

The presented invention relates to a sale decision method and a sale request evaluation method, more particularly, to a sale decision method and a sale request evaluation method capable of increasing the revenue by selling available products.

2. Description of Related Art

Due to widened wealth gap and differences in consumer behaviors, different customers will pay different prices for the same product. The Revenue management is a series of managing process for maximizing the revenue obtained from selling available products. To achieve this objective, a company should sell the products at a higher price to customers willing to pay a higher price, and sell the products at a lower price to customers willing to pay a lower price. For example, the airline company divides the seats of the same class into different price classes. Once a sale request of a customer arrives, the airline company's booking system needs to make a decision of refusing-or-agreeing the sale request promptly. However, the customer arriving earlier may be willing to pay a lower price; whereas, the customer willing to pay a higher price may arrive later. Therefore, when a sale request of a customer arrives, the booking system needs to compare the price that the current arrival customer willing to pay and the prices that later arrival customers will pay. But, the arrival times of future customers and the prices these customers willing to pay are both uncertain, how to make a correct refusing-or-agreeing decision under this uncertain circumstance is presented in this invention.

In the current industry practices, the future customers are divided into different price classes, representing different prices that customers are willing to pay. The customers of the same price class pay the same price for the product. These customers will arrive at a later time to buy the product of a limited quantity. The arrival process of the future customers is assumed as a known non-homogeneous Poisson random arrival process or other stochastic processes. The expected arrival rate of the future customers is a function of time.

Besides, the exact numbers of customers of different price classes arriving in the future are uncertain. If a product is sold to a customer of lower price class at a lower price, there may not be enough products to sell to a customer of a higher price class who arrives later. On the other hand, if the sale request of the customer willing to pay a lower price is refused, the product may be remain unsold at the end of the sale period, for example, at the departure time of the flight. This will cause a financial loss to the airline company.

The current booking policy of the airline company is described as follows: they divide the seats of the same class (for example, the economy-class seats of a flight) into different price classes, wherein the different price classes correspond to different limitation (for example, 1-year valid ticket or 6-months valid ticket). Each price class is corresponding to a price. For example, the airline company divides the 60 economy-class seats of a flight into 25 seats of “1-year valid ticket” and 35 seats of “6-months valid ticket”. Once a customer makes a reservation request to one of the above two different price classes, for example, the “6-months valid ticket”, the airline company will not refuse the sale request until the number of available seats of the price class becomes zero.

The invented sale decision method is capable of increasing the revenue by selling available products and responding the sale request with a refuse-to-sell decision or an agree-to-sell decision promptly.

In other practical applications of selling a product type with a limited quantity, a company normally relies on the past experience (for example, the popularity of the product) to quote the sale request of a customer. This quoting process based on human judgement may result in a huge financial loss due to wrong quotation of price for the requested product. Thus, a sale request evaluation method is necessary to increase the revenue from selling the available products by making correct quotation of price for a sale request.

Therefore, it is desirable to provide an improved speech recognition method to mitigate and/or obviate the aforementioned problems.

### SUMMARY OF THE INVENTION

The objective of the present invention is to provide a sale decision method capable of increasing the revenue by selling available products and responding to a sale request with a refuse-to-sell decision or an agree-to-sell decision promptly.

The objective of the present invention is to provide a sale request evaluation method capable of increasing the revenue by selling available products and responding to a sale request with a quotation of price promptly.

To achieve the objective, the sale decision method of the presented invention is applied in a sale decision system including an input module, a database module, a decision computation module, and an output module. At least one product group is stored in the database module. The decision computation module is coupled with the input module and the database module, respectively. The output module is coupled with the decision computation module. The sale decision method comprises the following steps: executing a sale request receiving process; executing a sale decision making process; and executing a sale decision output process.

At a customer arrival time, the input module in the sale request receiving process receives a sale request involving a requested product group and a request total price. The requested product group includes at least one requested product category, and the at least one requested product category corresponds to a requested product quantity.

In the sale decision making process, the decision computation module computes and outputs an agree-to-sell decision or a refuse-to-sell decision. The output module receives the agree-to-sell decision or the refuse-to-sell decision from the sale decision output process to output an agree-to-sell signal or a refuse-to-sell signal.

The at least one product group includes at least one product category, and the at least one product category corresponds to an available-for-sale product quantity. The at least one product group corresponds to at least one product price class. The at least one product price class corresponds to the arrival rate of a product price class. The at least one requested product group corresponds to the at least one product group, while the requested product quantity corresponds to the available-for-sale product quantity.

In addition, when the input module receives the sale request at the customer arrival time, the decision computation module executes the sale decision making process to compute a set of possible requested quantities of the at least one product price class arriving from the arrival time of the customer into the future based on the arrival rates of product price classes. The decision computation module then creates a scenario tree having at least one level and consisting of a plurality of scenarios based on the sets of possible requested quantities of the at least one product price class. The decision computation module then computes the probability of each of the plurality of scenarios.

Then, under the condition of knowing the perfect information of each of the plurality of scenarios and refusing the sale request, the decision computation module computes the optimal revenue in each of the plurality of scenarios by considering each of the plurality of scenarios, and then multiplies the optimal revenue obtained in each of the plurality of scenarios with the probability thereof to obtain the expected revenue of each of the plurality of scenarios. The decision computation module sums up the expected revenue of each of the plurality of scenarios to obtain a first total expected revenue.

Under the condition of knowing the perfect information of each of the plurality of scenarios and agreeing the sale request, the decision computation module computes the optimal revenue in each of the plurality of scenarios by considering each of the plurality of scenarios, and then multiplies the optimal revenue obtained in each of the plurality of scenarios with the probability thereof to obtain the expected revenue of each of the plurality of scenarios. The decision computation module sums up the expected revenue of each of the plurality of scenarios to obtain a second total expected revenue;

The decision computation module computes a gap between the two total expected revenues based on the first total expected revenue and the second total expected revenue. The decision computation module then compares the gap between the two total expected revenues with the request total price. If the gap between the two total expected revenues is greater than the request total price, the decision computation module outputs the refuse-to-sell decision to the output module. If the gap between the two total expected revenues is not greater than the request total price, the decision computation module outputs the agree-to-sell decision to the output module, and the decision computation module subtracts the requested product quantity from the available-for-sale product quantity.

To achieve the objective, the sale request evaluation method of the presented invention is applied in a sale request evaluation system including an input module, a database module, a sale request evaluation module, and an output module. At least one product group is stored in the database module. The sale request evaluation module is coupled with the input module and the database module, respectively. The output module is coupled with the sale request evaluation module. The sale request evaluation method comprises the following steps: executing a sale request evaluation process; executing a sale request evaluation making process; and executing a sale request evaluation output process.

At a customer arrival time, the input module in the sale request evaluation process receives a sale request involving at least one requested product group. The at least one requested product group includes at least one requested product category and the at least one requested product category corresponds to a requested product quantity. In the sale request evaluation making process, the sale request evaluation module computes and outputs a quotation of price. The output module receives the quotation of price from the sale request evaluation output process to output a quotation-of-price signal.

The at least one product group includes at least one product category, and the at least one product category corresponds to an available-for-sale product quantity. The at least one product group corresponds to at least one product price class. The at least one product price class corresponds to the arrival rate of a product price class. The at least one requested product group corresponds to the at least one product group. The requested product quantity corresponds to the available-for-sale product quantity.

In addition, when the input module receives the sale request at the customer arrival time, the sale request evaluation module executes the sale request evaluation making process to compute the set of possible requested quantities of the at least one product price class arriving from the arrival time of the customer into the future based on the arrival rates of product price classes. The sale request evaluation module then creates a scenario tree having at least one level and consisting of a plurality of scenarios based on the sets of possible requested quantities of the at least one product price class. The sale request evaluation module then computes the probability of each of the plurality of scenarios.

Then, under the condition of knowing the perfect information of each of the plurality of scenarios and refusing the sale request, the sale request evaluation module computes the optimal revenue in each of the plurality of scenarios by considering each of the plurality of scenarios, and then multiplies the optimal revenue obtained in each of the plurality of scenarios with the probability thereof to obtain the expected revenue of each of the plurality of scenarios. The sale request evaluation module sums up the expected revenue of each of the plurality of scenarios to obtain a first total expected revenue.

Under the condition of knowing the perfect information of each of the plurality of scenarios and agreeing the sale request, the sale request evaluation module computes the optimal revenue in each of the plurality of scenarios by considering each of the plurality of scenarios, and then multiplies the optimal revenue obtained in each of the plurality of scenarios with the probability thereof to obtain the expected revenue of each of the plurality of scenarios. The sale request evaluation module sums up the expected revenue of each of the plurality of scenarios to obtain a second total expected revenue.

The sale request evaluation module computes a gap between the two total expected revenues based on the first total expected revenue and the second total expected revenue. The quotation of price is not smaller than the gap between the two total expected revenues.

To achieve the objective, the sale decision method of the presented invention is applied in a sale decision system including an input module, a database module, a decision computation module, and an output module. At least one product group is stored in the database module. The decision computation module is coupled with the input module and the database module, respectively. The output module is coupled with the decision computation module. The sale decision method comprises the following steps: executing the computation process to generate a reference group consisting of a plurality of gaps between the two total expected revenues; executing a sale request receiving process; executing a sale decision making process; and executing a sale decision output process.

The at least one product group includes at least one product category, and the at least one product category corresponds to an available-for-sale product quantity. The at least one product group corresponds to at least one product price class. The at least one product price class corresponds to the arrival rate of a product price class. The at least one requested product group corresponds to the at least one product group. The requested product quantity corresponds to the available-for-sale product quantity.

A reference group consists of a plurality of gaps between the two total expected revenues; and in the computing process to generate the reference group consisting of a plurality of gaps between the two total expected revenues, the decision computation module executes the following steps repeatedly at a recomputing time to compute the plurality of gaps between the two total expected revenues. The duration between the current time and the recomputing time is defined as a usage period of the reference group consisting of a plurality of gaps between the two total expected revenues, and the duration from the midpoint of the usage period of the reference group consisting of a plurality of gaps between the two total expected revenues into the future is defined as a customer arrival period. The steps executed by the decision computation module are: computing sets of possible requested quantities of the at least one product price class arriving in the customer arrival period based on the arrival rates of product price classes; creating a scenario tree having at least one level and consisting of a plurality of scenarios based on the sets of possible requested quantities of the at least one product price class; then, computing the probability of each of the plurality of scenarios; computing the optimal revenue in each of the plurality of scenarios after considering each of the plurality of scenarios under the condition of knowing the perfect information of each of the plurality of scenarios and refusing the sale request of one unit product; multiplying the optimal revenue obtained in each of the plurality of scenarios with the corresponding probability to obtain the expected revenue of each of the plurality of scenarios; summing up the expected revenue of each of the plurality of scenarios to obtain a first total expected revenue; computing the optimal revenue in each of the plurality of scenarios after considering each of the plurality of scenarios under the condition of knowing the perfect information of each of the plurality of scenarios and agreeing the sale request of one unit product; multiplying the optimal revenue obtained in each of the plurality of scenarios with the corresponding probability to obtain the expected revenue of each of the plurality of scenarios; summing up the expected revenue of each of the plurality of scenarios to obtain a second total expected revenue; computing one of the plurality of gaps between the two total expected revenues corresponding to the available-for-sale product quantity based on the first total expected revenue and the second total expected revenue; and subtracting 1 from the available-for-sale product quantity, then, repeating the above steps to compute other gaps between the two total expected revenues of the reference group consisting of a plurality of gaps between the two total expected revenues, until the available-for-sale product quantity is reduced to zero.

At a customer arrival time, the input module in the sale request evaluation process receives a sale request involving a requested product group and a request total price. The requested product group includes at least one requested product category and the at least one requested product category corresponds to a requested product quantity.

In the sale decision making process, the decision computation module computes and outputs an agree-to-sell decision or a refuse-to-sell decision based on the gap between the two total expected revenues corresponding to the current available-for-sale product quantity. If the gap between the two total expected revenues is greater than the request total price, the decision computation module outputs the refuse-to-sell decision to the output module. If the gap between the two total expected revenues is not greater than the request total price, the decision computation module outputs the agree-to-sell decision to the output module and the decision computation module subtracts the requested product quantity from the available-for-sale product quantity.

In the sale decision output process, the output module receives the agree-to-sell decision or the refuse-to-sell decision to output an agree-to-sell signal or a refuse-to-sell signal.

Other objectives, advantages, and novel features of the invention will become more apparent from the following detailed description with the accompanying drawings.

### BRIEF DESCRIPTION OF THE DRAWINGS

FIG. 1 is a perspective view of the sale decision system that the sale decision method according to the first embodiment of the presented invention being applied thereon.

FIG. 2 is a perspective view showing the parameters stored in the database module.

FIG. 3 is a perspective view of a sale request.

FIG. 4 is a flowchart displaying the sale decision method according to the first embodiment of the presented invention.

FIG. 5 is a perspective view showing a scenario tree consists of a plurality of scenarios.

FIG. 6 is a perspective view of the sale decision system that the sale decision method according to the second embodiment of the presented invention being applied thereon.

FIG. 7 is a perspective view of the sale request evaluation system that the sale request evaluation method according to the third embodiment of the presented invention being applied thereon.

FIG. 8 is a perspective view showing the parameters stored in the database module.

FIG. 9 is a perspective view of a sale request.

FIG. 10 is a flowchart displaying the sale request evaluation method according to the third embodiment of the presented invention.

FIG. 11 is a perspective view showing a scenario tree consists of a plurality of scenarios.

FIG. 12 is a flowchart displaying the sale decision method according to the fourth embodiment of the presented invention.

FIG. 13 is a flowchart displaying the computation process to generate the reference group consisting of a plurality of gaps between the two total expected revenues of the sale decision method according to the fourth embodiment of the presented invention.

### DETAILED DESCRIPTION OF THE PREFERRED EMBODIMENT

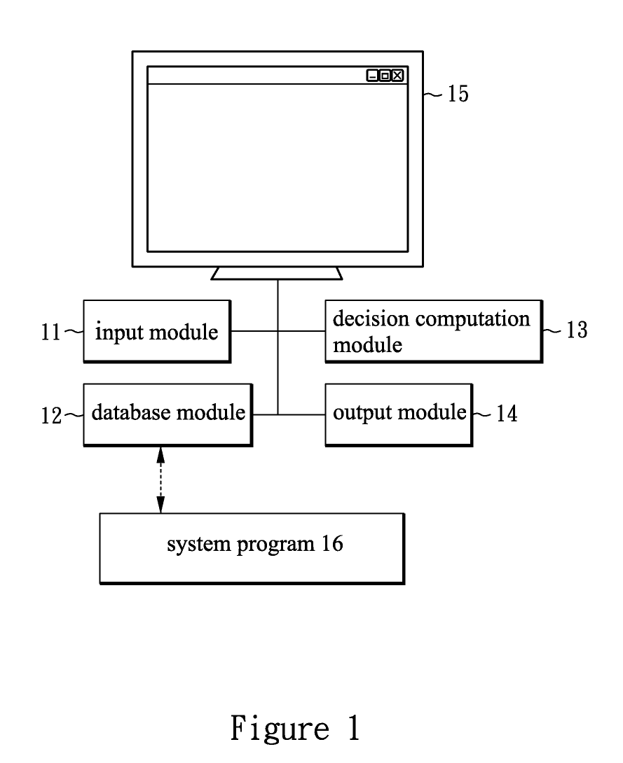

With reference to FIG. 1, which is a perspective view of the sale decision system that the sale decision method according to the first embodiment of the presented invention being applied thereon, the sale decision system includes an input module 11, a database module 12, a decision computation module 13, an output module 14, and a display module 15, wherein the decision computation module 13 is coupled with the input module 11 and the database module 12, respectively. In addition, the output module 14 is coupled with the decision computation module 13, and the display module 15 is coupled with the output module 14.

In the presented embodiment, the input module 11 can be used to input data, such as image, characters, instruction, etc, into the sale decision system. The database module 12 can be a hard drive, optical disc player, or a remote database through Internet connection to store system program, application program, user data, etc. In addition, the decision computation module 13 is used to compute and process data, such as making an agree-to-sell decision or a refuse-to-sell decision. The output module 14 is used to output the decision result, for example, to the display module 15 or an Internet booking server (not shown in the figure). Moreover, as shown in FIG. 1, the sale decision system operates under a system program 16 to execute many application programs such as a text processing program, a drawing program, a scientific computing program, a browsing program, an electronic mail program, or a software program capable of executing the sale decision method of the presented invention.

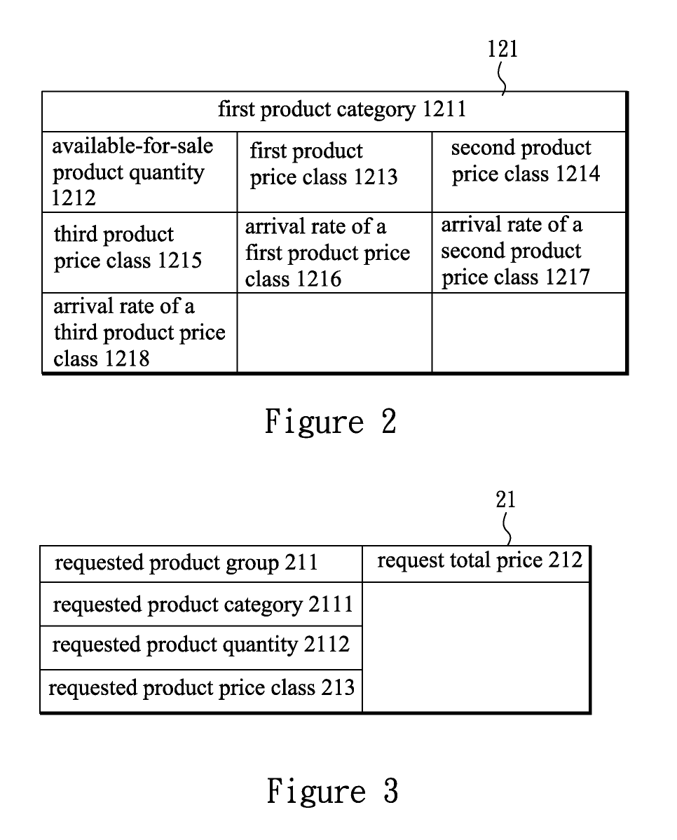

As shown in FIG. 2, in the presented embodiment, a product group 121 is stored in the database module 12 of the aforementioned sale decision system. Also, the product group 121 includes a first product category 1211 (for example, the economy-class seats of a flight), wherein the first product category 1211 corresponds to an available-for-sale product quantity 1212. Moreover, the product group 121 corresponds to a first product price class 1213, a second product price class 1214, and a third product price class 1215. The first product price class 1213 corresponds to the arrival rate of a first product price class 1216, the second product price class 1214 corresponds to the arrival rate of a second product price class 1217, and the third product price class 1215 corresponds to the arrival rate of a third product price class 1218.

In addition, the price of the first product price class 1213 is higher than that of the second product price class 1214, while the price of the second product price class 1214 is higher than that of the third product price class 1215. The aforementioned arrival rate of the first product price class 1216, the arrival rate of the second product price class 1217, and the arrival rate of the third product price class 1218 are used to describe the arrival behavior of the non-homogeneous Poisson random arrival process.

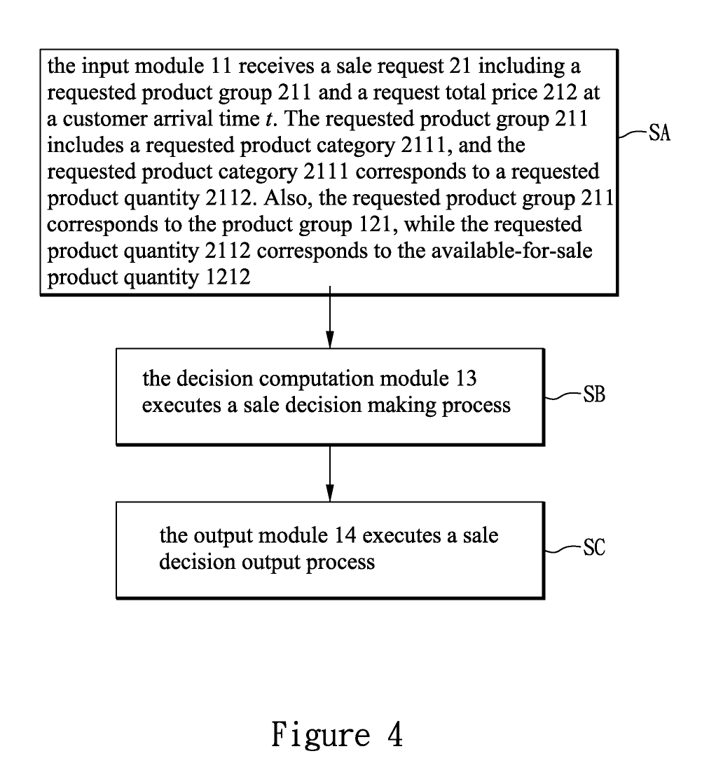

Please refer to FIGS. 1, 2, 3 and 4. FIG. 3 is a perspective view of a sale request, and FIG. 4 is the flowchart of the sale decision method used in the first embodiment of the presented invention.

The sale decision method used in the first embodiment of the presented invention comprises the following steps:

Step SA: the input module 11 receives a sale request 21 including a requested product group 211 and a request total price 212 at a customer arrival time t. The requested product group 211 includes a requested product category 2111, and the requested product category 2111 corresponds to a requested product quantity 2112. Also, the requested product group 211 corresponds to the product group 121, while the requested product quantity 2112 corresponds to the available-for-sale product quantity 1212;

Step SB: the decision computation module 13 executes a sale decision making process; and

Step SC: the output module 14 executes a sale decision output process.

When the input module 11 receives the sale request 21 at a customer arrival time t, the decision computation module 13 executes the sale decision making process of the step SB to compute three sets of possible requested quantities of the aforementioned three product price classes (i. e. U₁, U₂, and U₃) arriving from the customer arrival time t into the future based on the arrival rates of product price classes (i.e. the arrival rate of the first product price class 1216, the arrival rate of the second product price class 1217, and the arrival rate of the third product price class 1218).

Of course, the customer arrival time t is in a sale period.

Moreover, by computing the sets of possible requested quantities of the aforementioned three product price classes (U₁, U₂, and U₃) arriving from the customer arrival time t into the future, the decision computation module 13 determines whether the requested product quantity 2112 is not larger than the available-for-sale product quantity 1212. If the requested product quantity 2112 is larger than the available-for-sale product quantity 1212, the decision computation module 13 then outputs the refuse-to-sell decision (not shown in the figure) to the output module 14.

Then, if the requested product quantity 2112 is not larger than the available-for-sale product quantity 1212, the decision computation module 13 determines whether the request product price class 2113 corresponds to the first product price class 1213. If the request product price class 2113 is the first product price class 1213, the decision computation module 13 then outputs the agree-to-sell decision (not shown in the figure) to the output module 14 and subtracts the requested product quantity 2112 from the available-for-sale product quantity 1212.

The decision computation module 13 creates a scenario tree having at least one level and consisting of a plurality of scenarios, based on the sets of possible requested quantities of the aforementioned three product price classes (U₁, U₂, and U₃). The decision computation module 13 then computes the probability of each of the plurality of scenarios.

Then, under the condition of knowing the perfect information of each of the plurality of scenarios and refusing the sale request 21, the decision computation module 13 computes the optimal revenue. Then, the decision computation module 13 multiplies the optimal revenue in each of the plurality of scenarios with the corresponding probability to obtain the expected revenue of each of the plurality of scenarios. Then, the decision computation module 13 sums up the expected revenue of each of the plurality of scenarios to obtain a first total expected revenue E(Rₜ(S)|D=DUPI).

Additionally, under the condition of knowing the perfect information of each of the plurality of scenarios and agreeing the sale request 21, the decision computation module 13 computes the optimal revenue. Then, the module multiplies the optimal revenue in each of the plurality of scenarios with the corresponding probability to obtain the expected revenue of each of the plurality of scenarios. Then, the decision computation module 13 sums up the expected revenue of each of the plurality of scenarios to obtain a second total expected revenue E(Rₜ(S−X)|D=DUPI).

The decision computation module 13 computes a gap between the two total expected revenues E(Gₜ(S,X)|D=ERG) based on the first total expected revenue E(Rₜ(S)|D=DUPI) and the second total expected revenue E(Rₜ(S−X)|D=DUPI). The decision computation module 13 then compares the gap between the two total expected revenues E(Gₜ(S,X)|D=ERG) with the request total price 212:

If the gap between the two total expected revenues E(Gₜ(S,X)|D=ERG) is larger than the request total price 212, the decision computation module 13 outputs a refuse-to-sell decision (not shown in the figure) to the output module 14.

On the other hand, if the gap between the two total expected revenues E(Gₜ(S,X)|D=ERG) is not greater than the request total price 212, the decision computation module 13 outputs an agree-to-sell decision (not shown in the figure) to the output module 14, and the decision computation module 13 subtracts the requested product quantity 2112 from the available-for-sale product quantity 1212.

Finally, in the sale decision output process of the step SC, the output module 14 receives the agree-to-sell decision (not shown in the figure) or the refuse-to-sell decision (not shown in the figure) and outputs an agree-to-sell signal (not shown in the figure) or a refuse-to-sell signal (not shown in the figure). In the presented embodiment, the output module 14 is able to output the agree-to-sell signal (not shown in the figure) or the refuse-to-sell signal (not shown in the figure) to the display module 15 or an Internet booking server (not shown in the figure) to be used as a reference for a customer service agent or the aforementioned Internet booking server (not shown in the figure) in response to the sale request 21 by a customer.

Hereinafter, the sale decision method using the first embodiment of the presented invention will be detailed described by using an example.

In the presented embodiment, the aforementioned sale decision system is assumed to be a flight booking system, wherein the first product price class 1213, the second product price class 1214, and the third product price class 1215 corresponds to a first booking price class, a second booking price class, and a third booking price class, respectively. In addition, the sale request arrival process of the aforementioned three product price classes (i.e. the first product price class 1213, the second product price class 1214, and the third product price class 1215) are non-homogeneous Poisson random arrival processes. In other examples, the sale request arrival process of the aforementioned three product price classes can also be other stochastic arrival processes with known probability descriptions.

In the example, the price of the first product price class 1213 is $300, that of the second product price class 1214 is $200, and that of the third product price class 1215 is $100. In addition, the available-for-sale product quantity 1212 is 10. In this flight booking system, the sale period (i.e. the booking horizon) is set to be 10 days before the departure time of the flight. The 10-days sale period is further divided into two 5-days sub-periods.

In this example, the arrival rate of the first product price class 1216 (represented by λ₁(t)), the arrival rate of the second product price class 1217 (represented by λ₂(t)), and the arrival rate of the third product price class 1218 (represented by λ₃(t)) are function of time. They are:

$${λ}_{1} ( t ) = \{ \begin{matrix}0.2 & if t ∈ [ 0 , 5 ) \\ 0.6 & if t ∈ ( 5 , 10 ]\end{matrix} \\ {λ}_{2} ( t ) = \{ \begin{matrix}0.6 & if t ∈ [ 0 , 5 ) \\ 0.6 & if t ∈ ( 5 , 10 ]\end{matrix} \\ {λ}_{3} ( t ) = \{ \begin{matrix}1.1 & if t ∈ [ 0 , 5 ) \\ 0.5 & if t ∈ ( 5 , 10 ]\end{matrix}$$

Wherein, t∈[0,5) represents the 5-day sub-period starting from 10 days before the departure time of the flight, to 6 days before the departure time of the flight. t∈(5,10] represents the 5-day sub-period starting from 5 days before the departure time of the flight to the departure time of the flight.

In the sale request 21 received by the input module 11 of this example, the requested product group 211 includes only one requested product category 2111(for example, economy-class of the flight). Also, the requested product quantity 2112 of the requested product category 2111 is 1; that is, only one seat is requested at a time.

The request number, the booking price class, the request product price class, the customer arrival time t, the gap between the two total expected revenues, the result of the sale decision, and the number of seats available for booking (i.e. the available-for-sale product quantity 1212) are listed in Table 1.

TABLE 1

| | | | | | | | Gap | | |
|---|---|---|---|---|---|---|---|---|---|
| | | Request | | | | | between the | Result | |
| No. of | Booking | product | Customer | | | | two total | of the | No. of seats |
| the sale | price | price | arrival | | | | expected | sale | available |
| request | class | class | time | n₁ₜ | n₂ₜ | n₃ₜ | revenue | decision | for booking |
| 1 | 3 | 100 | 0.3245 | 3.9351 | 5.8053 | 7.643 | 149.5 | Refuse | 10 |
| 2 | 3 | 100 | 0.9564 | 3.8087 | 5.4262 | 6.948 | 140.98 | Refuse | 10 |
| 3 | 2 | 200 | 1.3758 | 3.7248 | 5.1745 | 6.4866 | 134.6 | Agree | 9 |
| 4 | 1 | 300 | 2.1124 | — | — | — | — | Agree | 8 |
| 5 | 2 | 200 | 2.9578 | 3.4084 | 4.2253 | 4.7464 | 144.4 | Agree | 7 |
| 6 | 3 | 100 | 3.3145 | 3.3371 | 4.0113 | 4.3541 | 160.03 | Refuse | 7 |
| 7 | 3 | 100 | 3.8547 | 3.2291 | 3.6872 | 3.7598 | 149.11 | Refuse | 7 |
| 8 | 2 | 200 | 4.0421 | 3.1916 | 3.5747 | 3.5537 | 144.78 | Agree | 6 |
| 9 | 3 | 100 | 4.4703 | 3.1059 | 3.3178 | 3.0827 | 162.66 | Refuse | 6 |
| 10 | 3 | 100 | 4.9512 | 3.0098 | 3.0293 | 2.5537 | 150.27 | Refuse | 6 |
| 11 | 3 | 100 | 5.2152 | 2.8709 | 2.8709 | 2.3924 | 140.42 | Refuse | 6 |
| 12 | 2 | 200 | 5.8545 | 2.4873 | 2.4873 | 2.0728 | 112.6 | Agree | 5 |
| 13 | 1 | 300 | 6.5258 | — | — | — | — | Agree | 4 |
| 14 | 2 | 200 | 7.064 | 1.7616 | 1.7616 | 1.468 | 130.47 | Agree | 3 |
| 15 | 3 | 100 | 7.2456 | 1.6526 | 1.6526 | 1.3772 | 171.78 | Refuse | 3 |
| 16 | 2 | 200 | 8.2977 | 1.0214 | 1.0214 | 0.8511 | 97.17 | Agree | 2 |
| 17 | 1 | 300 | 8.9221 | — | — | — | — | Agree | 1 |
| 18 | 1 | 300 | 9.2514 | — | — | — | — | Agree | 0 |

As shown in Table 1, when the customer arrival at time t=0.3245, the input module 11 receives a sale request 21 (No. 1) having the request product price class 2113 corresponding to the third product price class 1215, with the request total price 212 of $100 (step SA).

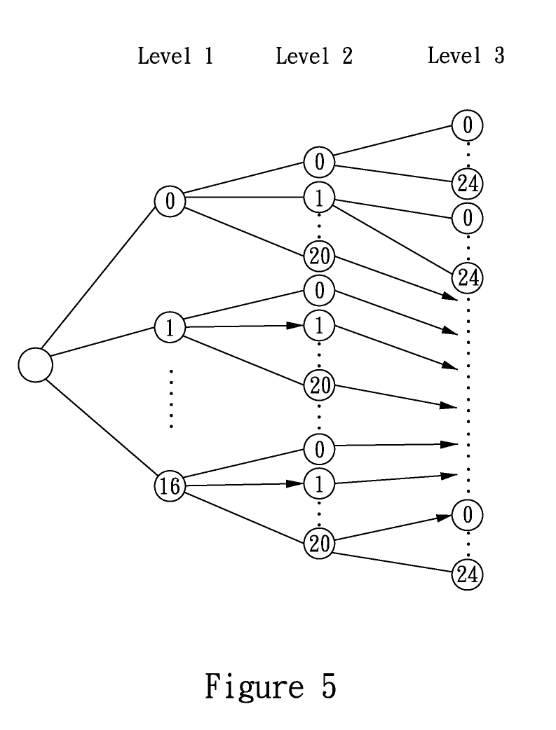

Then, the decision computation module 13 determines whether the requested product quantity 2112 is not larger than the available-for-sale product quantity 1212. Since the number of seat requested for booking (i.e. the requested product quantity 2112) is currently not larger than the available-for-sale product quantity 1212 (1<10), the decision computation module 13 continues to determines whether or not the request product price class 2113 corresponds to the first product price class 1213. Since the request product price class 2113 corresponds to the third product price class 1215 (not the first product price class 1213), the decision computation module 13 computes the sets of possible requested quantities of the aforementioned three product price classes (U₁, U₂ and U₃) to create a scenario tree having at least one level. The scenario tree consists of a plurality of scenarios, as shown in FIG. 5.

The number of the levels of the scenario tree is equal to the number of the product price class. In this example, the number of the levels of the scenario tree is 3. The number of the plurality of scenarios is the product of the number of the elements in the set of the first possible requested quantities U₁, the number of the elements in the set of the second possible requested quantities U₂, and the number of the elements in the set of the third possible requested quantities U₃.

The computation process of the set of the first possible requested quantities U₁, the set of the second possible requested quantities U₂, and the set of the third possible requested quantities U₃ are described as follows.

The decision computation module 13 creates the scenario tree in FIG. 5 with the arrival rate of the first product price class 1216(represented by λ₁(t)), the arrival rate of the second product price class 1217(represented by λ₂(t)), the arrival rate of the third product price class 1218 (represented by λ₃(t)), and the customer arrival time t.

Since the arrival number of the first product price class 1213 N₁ₜ, the arrival number of the second product price class 1214 N₂ₜ, and the arrival number of the third product price class 1215 N₃ₜ are Poisson random variables, their expected values (n₁ₜ, n₂ₜ, and n₃ₜ) of them can be computed as follows:

n₁ₜ=0.2×(5−0.3245)+0.6×5=3.9351

n₂ₜ=0.6×(5−0.3245)+0.6×5=5.8053

n₃ₜ=1.1×(5−0.3245)+0.5×5=7.643

It should be noted that, to simplify the numerical computation, if the probability of any of the plurality of scenarios of the scenario tree in FIG. 5 is close to zero, for instance, being smaller than 10⁻⁶, the probability of the scenario is set to be zero in the computation of the first total expected revenue or the computation of the second total expected revenue.

As a result, the set of the first possible requested quantities U₁, the set of the second possible requested quantities U₂, and the set of the third possible requested quantities U₃ can be shown as follows.

$$\begin{matrix}{U}_{1} = \{ x \vert P ( {N}_{1 t} = x ) = \frac{{{e}^{- 3.9351} ( 3.9351 )}^{x}}{x !} > {10}^{- 6} \} \\ = \{ 0 , 1 , 2 , … , 16 \}\end{matrix}$$

$$\begin{matrix}{U}_{2} = \{ x \vert P ( {N}_{2 t} = x ) = \frac{{{e}^{- 5.8053} ( 5.8053 )}^{x}}{x !} > {10}^{- 6} \} \\ = \{ 0 , 1 , 2 , … , 20 \}\end{matrix}$$

$$\begin{matrix}{U}_{3} = \{ x \vert P ( {N}_{3 t} = x ) = \frac{{{e}^{- 7.643} ( 7.643 )}^{x}}{x !} > {10}^{- 6} \} \\ = \{ 0 , 1 , 2 , … , 24 \}\end{matrix}$$

Once the set of the first possible requested quantities U₁, the set of the second possible requested quantities U₂, and the set of the third possible requested quantities U₃ are obtained, the scenario tree in FIG. 5 can be created.

After the scenario tree is created, the decision computation module 13 computes a probability corresponding to each of the plurality of scenarios of the scenario tree. Then, under the condition of knowing the perfect information of each of the plurality of scenarios and refusing the current sale request 21, the decision computation module 13 computes the optimal revenue. Under the perfect information on the requests of each product price class, the available products can be optimally allocated to the known requests to obtain optimal revenue. The decision computation module 13 multiplies the optimal revenue obtained in each of the plurality of scenarios with the corresponding probability to obtain the expected revenue of each of the plurality of scenarios. The decision computation module 13 then sums up the expected revenue of each of the plurality of scenarios to obtain a first total expected revenue E(Rₜ(S)|D=DUPI). By computing all of the plurality of scenarios of the scenario tree under the condition of knowing the perfect information of each of the plurality of scenarios and refusing the sale request 21, the first total expected revenue E(Rₜ(S)|D=DUPI) is $2251.88.

In addition, under the condition of knowing the perfect information of each of the plurality of scenarios and agreeing the sale request 21, the decision computation module 13 computes the optimal revenue. Then, the decision computation module 13 multiplies the optimal revenue obtained in each of the plurality of scenarios with the corresponding probability to obtain the expected revenue of each of the plurality of scenarios. The decision computation module 13 then sums up the expected revenue of each of the plurality of scenarios to obtain a second total expected revenue E(Rₜ(S−X)|D=DUPI). By computing all of the plurality of scenarios of the scenario tree under the condition of knowing the perfect information of each of the plurality of scenarios and agreeing the sale request 21, the second total expected revenue E(Rₜ(S−X)|D=DUPI) obtained is $2102.38. As a result, the gap between the two total expected revenues E(Gₜ(S,X)|D=ERG) is $149.5.

Then, the decision computation module 13 compares the gap between the two total expected revenues E(Gₜ(S,X)|D=ERG) with the request total price 212. In this case, since the expected revenue gap ($149.5) is higher than the request total price 212 ($100), the decision computation module 13 outputs the refuse-to-sell decision (not shown in the figure) to the output module 14. The output module 14 outputs the refuse-to-sell signal (not shown in the figure) correspondingly.

Refer to Table 1 again. When the customer arrival time t=2.1124, the input module 11 receives a sale request 21 (No. 4) having the request product price class 2113 corresponding to the first product price class 1213, with the request total price 212 of $300. Then, as described above, the decision computation module 13 determines whether the requested product quantity 2112 is not larger than the available-for-sale product quantity 1212. At this time, since the number of seat requested for booking (i.e. the requested product quantity 2112) is not larger than the available-for-sale product quantity 1212 (1<9), the decision computation module 13 continues to determines whether the request product price class 2113 corresponds to the first product price class 1213. As the request product price class 2113 corresponds to the first product price class 1213, the decision computation module 13 outputs the agree-to-sell decision (not shown in the figure) to the output module 14 and subtracts the requested product quantity 2112 (1) from the available-for-sale product quantity 1212 (9). That is the number shown in the column of “No. of seats available for booking” on the row corresponding to the No. 4 sale request. Then, the sale decision method of to the first embodiment of the presented invention is executed again only when the input module 11 receives another sale request at another customer arrival time t. However, until the available-for-sale product quantity 1212 being reduced to zero, the sale decision method of the first embodiment of the presented invention will be executed.

As shown in Table 1, the sale decision system that the sale decision method of the first embodiment of the presented invention agrees the sale requests of No. 3, No. 4, No. 5, No. 8, No. 12, No. 13, No. 14, No. 16, No. 17, and No. 18. The revenue obtained after selling all seats is $2400, which is larger than the revenue obtained in the sale decision system using the conventional “first come first service” rule, which is $1500. By using the “first come first service” rule, the sale decision system agrees the first 10 sale request (i.e. sale requests of No. 1-No. 10).

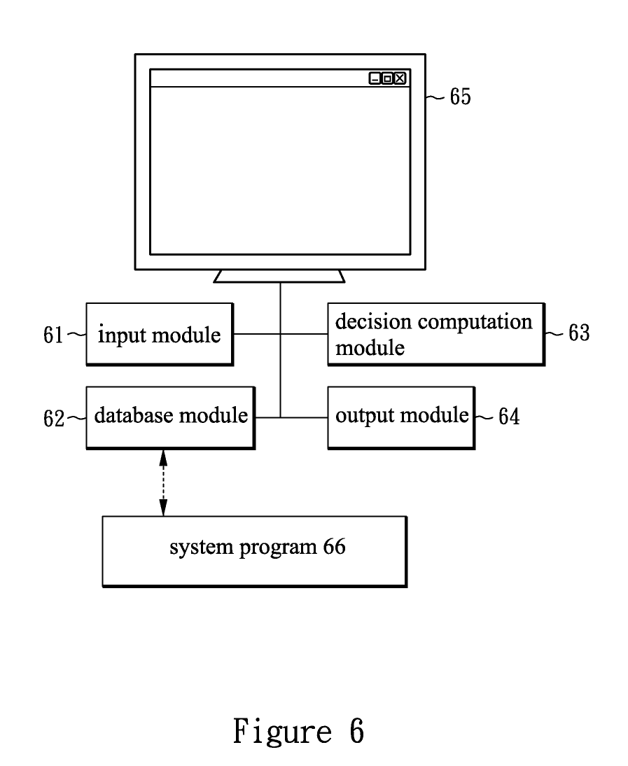

With reference to FIG. 6, which is a perspective view of the sale decision system that the sale decision method according to the second embodiment of the presented invention being applied thereon, the sale decision system includes an input module 61, a database module 62, a decision computation module 63, an output module 64, and a display module 65. The decision computation module 63 is coupled with the input module 61 and the database module 62, respectively. Additionally, the output module 64 is coupled with the decision computation module 63, and the display module 65 is coupled with the output module 64.

In the presented embodiment, the input module 61 can be used to input data, such as image, characters, instruction, etc, into the sale decision system. The database module 62 can be a hard drive, optical disc player, or a remote database through Internet connection to store system program, application program, user data, etc. In addition, the decision computation module 63 is used to compute and process data, such as making an agree-to-sell decision or a refuse-to-sell decision. The output module 64 is used to output the decision to the display module 65 or an Internet booking server (not shown in the figure). Moreover, as shown in FIG. 6, the sale decision system operates under a system program 66 to execute many application programs, such as a text processing program, a drawing program, a scientific computing program, a browsing program, an electronic mail program, or a software program capable of computing the sale decision method of the presented invention.

Since in the presented embodiment, the product group is the same as the product group 121 of the first embodiment of the presented invention, the detailed description on the composition and the characteristic of the product group is omitted herein. For the same reason, as the sale request of the presented embodiment is the same as the sale request 21 of the first embodiment of the presented invention, the detailed description on the composition and the characteristic of the sale request is omitted herein, too.

Moreover, since the sale decision method of the second embodiment of the presented invention is similar to the sale decision method of the first embodiment of the presented invention, the only difference thereinbetween is the detailed steps of the sale decision making process. Therefore, the flowchart of the sale decision method according to the second embodiment of the presented invention is omitted herein. Detailed description of the sale decision making process of the sale decision method of the second embodiment of the presented invention is provided as follows.

In the sale decision making process of the sale decision method of the second embodiment of the presented invention, the decision computation module computes sets of possible actual requested quantities of the three product price classes (U₁, U₂, and U₃) arriving from the customer arrival time t into the future, based on the arrival rates of a product price classes and their corresponding cancelling probabilities. Additionally, the customer arrival time t is in a sale period.

The sale decision method of the second embodiment of the presented invention will be thoroughly described by an example.

As the first embodiment, the aforementioned sale decision system is assumed to be a flight booking system, wherein the first product price class, the second product price class, and the third product price class correspond to a first booking price class, a second booking price class, and a third booking price class, respectively. Also, the sale request arrival processes of the aforementioned three product price classes are non-homogeneous Poisson random arrival processes. In other examples, the sale request arrival processes of the aforementioned three product price classes can also be other stochastic arrival processes with known probability descriptions. Moreover, the aforementioned at least one cancelling probability of a product price class corresponds to a product price class, and the aforementioned at least one cancelling probability of a product price class is a function of time.

In the example, the price of the first product price class is $300, the price of the second product price class is $200, and the price of the third product price class is $100. In addition, the available-for-sale product quantity is 10. Moreover, as a flight booking system, the sale period (i.e. the booking horizon) is set to be 10 days before the departure time of the flight. The 10-days sale period is further divided into two 5-day sub-periods.

In the example, the arrival rate of the first product price class (represented by λ₁(t)), the arrival rate of the second product price class (represented by λ₂(t)), and the arrival rate of the third product price class (represented by λ₃(t)) are function of time. They are:

$${λ}_{1} ( t ) = \{ \begin{matrix}0.25 & if t ∈ [ 0 , 5 ) \\ 0.6 & if t ∈ ( 5 , 10 ]\end{matrix} \\ {λ}_{2} ( t ) = \{ \begin{matrix}0.8 & if t ∈ [ 0 , 5 ) \\ 0.8 & if t ∈ ( 5 , 10 ]\end{matrix} \\ {λ}_{3} ( t ) = \{ \begin{matrix}2.2 , & if t ∈ [ 0 , 5 ) \\ 0.5 , & if t ∈ [ 5 , 10 ]\end{matrix}$$

Wherein, t∈[0,5) represents the 5-day sub-period starting from 10 days before the departure time of the flight to 6 days before the departure time of the flight. t∈(5,10] represents the 5-day sub-period starting from 5 days before the departure time of the flight to the departure time of the flight.

Moreover, the cancelling probability of the first product price class (represented by p₁(t)), the cancelling probability of the second product price class (represented by p₂(t)), and the cancelling probability of the third product price class (represented by p₃(t)) are function of time. They are:

$${p}_{1} ( t ) = \{ \begin{matrix}0.2 & if t ∈ [ 0 , 5 ) \\ 0.0 & if t ∈ ( 5 , 10 ]\end{matrix} \\ {p}_{2} ( t ) = \{ \begin{matrix}0.25 & if t ∈ [ 0 , 5 ) \\ 0.25 & if t ∈ ( 5 , 10 ]\end{matrix} \\ {p}_{3} ( t ) = \{ \begin{matrix}0.5 , & if t ∈ [ 0 , 5 ) \\ 0.0 , & if t ∈ [ 5 , 10 ]\end{matrix}$$

As a result, the actual arrival rate of a product price class of each of the three product price classes (i.e. the actual arrival rate of the first product price class, the actual arrival rate of the second product price class, and the actual arrival rate of the third product price class) are calculated as follows:

$${λ}_{1} ( t ) = \{ \begin{matrix}0.2 ( = 0.25 \times 0.8 ) & if t ∈ [ 0 , 5 ) \\ 0.6 ( = 0.6 \times 1.0 ) & if t ∈ ( 5 , 10 ]\end{matrix} \\ {λ}_{2} ( t ) = \{ \begin{matrix}0.6 ( = 0.8 \times 0.75 ) & if t ∈ [ 0 , 5 ) \\ 0.6 ( = 0.8 \times 0.75 ) & if t ∈ ( 5 , 10 ]\end{matrix} \\ {λ}_{3} ( t ) = \{ \begin{matrix}1.1 ( = 2.2 \times 0.5 ) , & if t ∈ [ 0 , 5 ) \\ 0.5 ( = 0.5 \times 1.0 ) , & if t ∈ [ 5 , 10 ]\end{matrix}$$

In the presented example, in the sale request received by the input module 61, the requested product group includes only one requested product category (for example, economy-class of the flight). Also, the requested product quantity of the requested product category is 1; that is, only one seat is requested for sale at a time. The request number, the booking price class, the request product price class, the customer arrival time t, the gap between the two total expected revenues, the result of the sale decision, and the number of seats available for booking (i.e. the available-for-sale product quantity) are listed in the following Table 2.

TABLE 2

| | | | | | | | Gap | | |
|---|---|---|---|---|---|---|---|---|---|
| | | | | | | | between | | No. of |
| No. of | | Request | | | | | the two | Result | seats |
| the | Booking | product | Customer | | | | total | of the | available |
| sale | price | price | arrival | | | | expected | sale | for |
| request | class | class | time | n₁ₜ | n₂ₜ | n₃ₜ | revenue | decision | booking |
| 1 | 3 | 100 | 0.3245 | 3.9351 | 5.8053 | 7.643 | 149.5 | Refuse | 10 |
| 2 | 3 | 100 | 0.9564 | 3.8087 | 5.4262 | 6.948 | 140.98 | Refuse | 10 |
| 3 | 2 | 200 | 1.3758 | 3.7248 | 5.1745 | 6.4866 | 134.6 | Agree | 9 |
| 4 | 1 | 300 | 2.1124 | — | — | — | — | Agree | 8 |
| 5 | 2 | 200 | 2.9578 | 3.4084 | 4.2253 | 4.7464 | 144.4 | Agree | 7 |
| 6 | 3 | 100 | 3.3145 | 3.3371 | 4.0113 | 4.3541 | 160.03 | Refuse | 7 |
| 7 | 3 | 100 | 3.8547 | 3.2291 | 3.6872 | 3.7598 | 149.11 | Refuse | 7 |
| 8 | 2 | 200 | 4.0421 | 3.1916 | 3.5747 | 3.5537 | 144.78 | Agree | 6 |
| 9 | 3 | 100 | 4.4703 | 3.1059 | 3.3178 | 3.0827 | 162.66 | Refuse | 6 |
| 10 | 3 | 100 | 4.9512 | 3.0098 | 3.0293 | 2.5537 | 150.27 | Refuse | 6 |
| 11 | 3 | 100 | 5.2152 | 2.8709 | 2.8709 | 2.3924 | 140.42 | Refuse | 6 |
| 12 | 2 | 200 | 5.8545 | 2.4873 | 2.4873 | 2.0728 | 112.6 | Agree | 5 |
| 13 | 1 | 300 | 6.5258 | — | — | — | — | Agree | 4 |
| 14 | 2 | 200 | 7.064 | 1.7616 | 1.7616 | 1.468 | 130.47 | Agree | 3 |
| 15 | 3 | 100 | 7.2456 | 1.6526 | 1.6526 | 1.3772 | 171.78 | Refuse | 3 |
| 16 | 2 | 200 | 8.2977 | 1.0214 | 1.0214 | 0.8511 | 97.17 | Agree | 2 |
| 17 | 1 | 300 | 8.9221 | — | — | — | — | Agree | 1 |
| 18 | 1 | 300 | 9.2514 | — | — | — | — | Agree | 0 |

As shown in Table 2, when the customer arrival at time t=0.3245, the input module 61 receives a sale request 21 (No. 1) having the request product price class corresponding to the third product price class, with the request total price of $100.

Then, the decision computation module 63 determines whether the requested product quantity is not larger than the available-for-sale product quantity. Since the number of seat requested for booking (i.e. the requested product quantity) is not greater than the available-for-sale product quantity (1<10), the decision computation module 63 continues to determines whether or not the request product price class corresponds to the first product price class. Since the request product price class corresponds to the third product price class (not the first product price class), the decision computation module 63 computes the sets of possible actual requested quantities of the aforementioned three product price classes (U₁, U₂, and U₃) to create a scenario tree having at least one level and consisting of a plurality of scenarios.

The number of the levels of the scenario tree is equal to the number of the at least one product price class. In this example, the number of the levels of the scenario tree is 3. The number of the plurality of scenarios is the product of the number of the elements in the set of first possible actual requested quantities U₁, the number of the elements in the set of second possible actual requested quantities U₂, and the number of the elements in the set of third possible actual requested quantities U₃.

The computation process of the set of first possible actual requested quantities U₁, the set of second possible actual requested quantities U₂, and the set of third possible actual requested quantities U₃ are described below:

The decision computation module 63 creates the scenario tree with the amended arrival rate of the first product price class, the amended arrival rate of the second product price class, and the amended arrival rate of the third product price class, and the customer arrival time t.

Since, the arrival number of the first product price class N₁ₜ, the arrival number of the second product price class N₂ₜ, and the arrival number of the third product price class N₃ₜ are Poisson random variables, the expected value (n₁ₜ, n₂ₜ, and n₃ₜ,) of them can be computed as follows.

n₁ₜ=0.2×(5−0.3245)+0.6×5=3.9351

n₂ₜ=0.6×(5−0.3245)+0.6×5=5.8053

n₃ₜ=1.1×(5−0.3245)+0.5×5=7.643

It should be noted that, to simplify the numerical computation, if the probability of any of the plurality of scenarios of the scenario tree is close to zero, for instance, being smaller than 10⁻⁶, the probability of the scenario is set to be zero in the computation of the first total expected revenue or the computation of the second total expected revenue

As a result, the set of first possible actual requested quantities U₁, the set of second possible actual requested quantities U₂, and the set of third possible actual requested quantities U₃ are as follows:

$$\begin{matrix}{U}_{1} = \{ x \vert P ( {N}_{1 t} = x ) = \frac{{{e}^{- 3.9351} ( 3.9351 )}^{x}}{x !} > {10}^{- 6} \} \\ = \{ 0 , 1 , 2 , … , 16 \}\end{matrix}$$

$$\begin{matrix}{U}_{2} = \{ x \vert P ( {N}_{2 t} = x ) = \frac{{{e}^{- 5.8053} ( 5.8053 )}^{x}}{x !} > {10}^{- 6} \} \\ = \{ 0 , 1 , 2 , … , 20 \}\end{matrix}$$

$$\begin{matrix}{U}_{3} = \{ x \vert P ( {N}_{3 t} = x ) = \frac{{{e}^{- 7.643} ( 7.643 )}^{x}}{x !} > {10}^{- 6} \} \\ = \{ 0 , 1 , 2 , … , 24 \}\end{matrix}$$

Once the set of first possible actual requested quantities U₁, the set of second possible actual requested quantities U₂, and the set of third possible actual requested quantities U₃ are obtained, the scenario tree can be created.

After the scenario tree is created, the decision computation module 63 computes the probability of each of the plurality of scenarios of the scenario tree. Then, under the condition of knowing the perfect information of each of the plurality of scenarios and refusing the sale request, the decision computation module 63 computes the optimal revenue. Under the perfect information on the requests of each product price class, the available products can be optimally allocated to the known requests to obtain optimal revenue. The decision computation module 63 multiplies the optimal revenue obtained in each of the plurality of scenarios with the corresponding probability, to obtain the expected revenue of each of the plurality of scenarios. The decision computation module 63 then sums up the expected revenue of each of the plurality of scenarios to obtain a first total expected revenue E(Rₜ(S)|D=DUPI). By computing all of the plurality of scenarios of the scenario tree under the condition of knowing the perfect information of each of the plurality of scenarios and refusing the sale request, the first total expected revenue E(Rₜ(S)|D=DUPI) obtained is $2251.88.

In addition, under the condition of knowing the perfect information of each of the plurality of scenarios and agreeing the sale request, the decision computation module 63 computes the optimal revenue. After computing each of the plurality of scenarios, and the decision computation module then multiplies the optimal revenue obtained in each of the plurality of scenarios with the corresponding probability to obtain the expected revenue of each of the plurality of scenarios. The decision computation module 63 then sums up the expected revenue of each of the plurality of scenario to obtain a second total expected revenue E(Rₜ(S−X)|D=DUPI). By computing all of the plurality of scenarios of the scenario tree under the condition of knowing the perfect information of each of the plurality of scenarios and agreeing the sale request, the second total expected revenue E(Rₜ(S−X)|D=DUPI) obtained is $2102.38. As a result, the gap between the two total expected revenues E(Gₜ(S,X)|D=ERG) is $149.5.

Then, the decision computation module 63 compares the gap between the two total expected revenues E(Gₜ(S,X)|D=ERG) with the request total price. In this case, since the expected revenue gap ($149.5) is higher than the request total price ($100), the decision computation module 63 outputs the refuse-to-sell decision (not shown in the figure) to the output module 64. The output module 64 outputs the refuse-to-sell signal (not shown in the figure), correspondingly.

Refer to Table 2 again, as the customer arrival time t=2.1124, the input module 61 receives a sale request (No. 4) having the request product price class corresponding to the first product price class with the request total price of $300. Then, as described above, the decision computation module 63 determines whether the requested product quantity is not larger than the available-for-sale product quantity. At this time, since the number of seat requested for booking (i.e. the requested product quantity) is not larger than the available-for-sale product quantity (1<9), the decision computation module 63 continues to determines whether the request product price class corresponds to the first product price class. At this time, as the request product price class corresponds to the first product price class, the decision computation module 63 outputs the agree-to-sell decision (not shown in the figure) to the output module 64 and subtracts the requested product quantity (1) from the available-for-sale product quantity (9). That is, the number shown in the column of “No. of seats available for booking” on the row corresponding to the No. 4 sale request.

Then, the sale decision method of the second embodiment of the presented invention is executed again only when the input module 61 receives another sale request at another customer arrival time t. However, until the available-for-sale product quantity being reduced to zero, the sale decision method of the second embodiment of the presented invention will be executed.

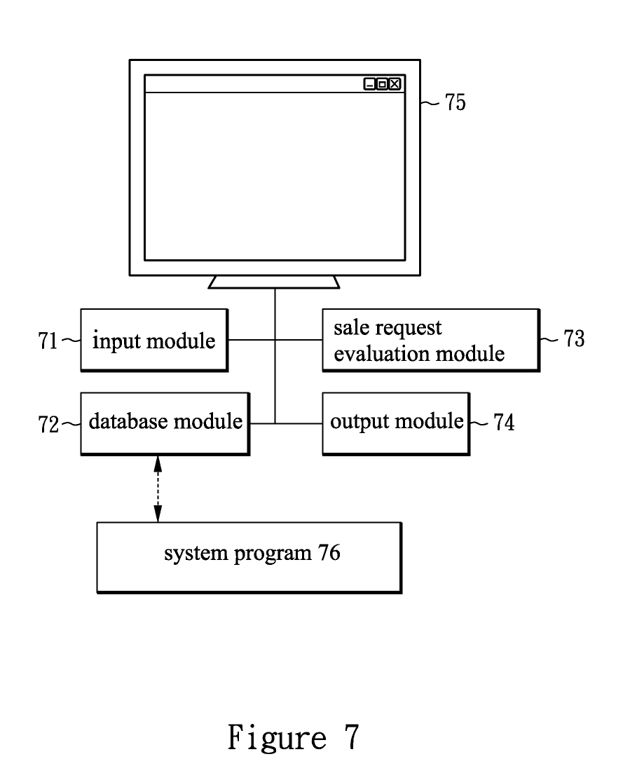

With reference to FIG. 7, which is a perspective view of the sale request evaluation system that the sale request evaluation method according to the third embodiment of the presented invention being applied thereon, the sale request evaluation system includes an input module 71, a database module 72, a sale request evaluation module 73, an output module 74, and a display module 75. The sale request evaluation module 73 is coupled with the input module 71 and the database module 72, respectively. Additionally, the output module 74 is coupled with the sale request evaluation module 73, and the display module 75 is coupled with the output module 74.

In the presented embodiment, the input module 71 can be used to input data, such as image, characters, instruction, etc, into the sale request evaluation system. The database module 72 can be a hard drive, optical disc player, or a remote database through Internet connection to store system program, application program, user data, etc. In addition, the sale request evaluation module 73 is used to compute and process data, such as computing the quotation of price of a sale request. The output module 74 is used to output the quotation of price, for example, to the display module 75 or an Internet booking server (not shown in the figure). Moreover, as shown in FIG. 7, the sale request evaluation system operates under a system program 76 to execute many application programs, such as a text processing program, a drawing program, a scientific computing program, a browsing program, an electronic mail program, or a software program capable of executing the sale request evaluation method of the presented invention.

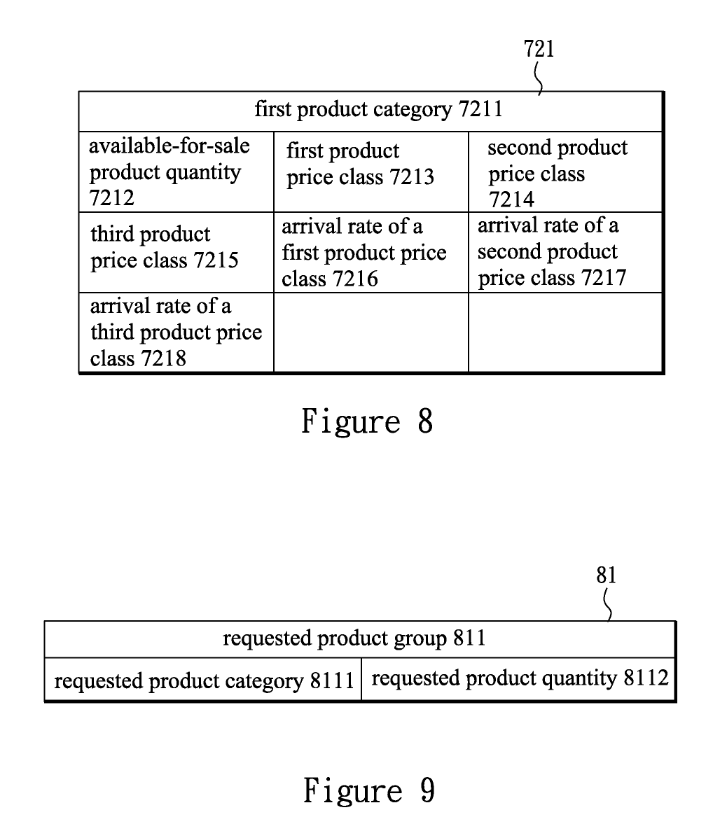

As shown in FIG. 8, in the presented embodiment, a product group 721 is stored in the database module 72 of the aforementioned sale request evaluation system. Also, the product group 721 includes a first product category 7211 (for example, a fashion clothes for sale on an Internet auction site), wherein the first product category 7211 corresponds to an available-for-sale product quantity 7212. Moreover, the product group 721 corresponds to a first product price class 7213, a second product price class 7214, and a third product price class 7215. The first product price class 7213 corresponds to the arrival rate of the first product price class 7216, the second product price class 7214 corresponds to the arrival rate of the second product price class 7217, and the third product price class 7215 corresponds to the arrival rate of the third product price class 7218.

In addition, the price of the first product price class 7213 is higher than that of the second product price class 7214, while the price of the second product price class 7214 is higher than that of the third product price class 7215. The aforementioned arrival rate of the first product price class 7216, the arrival rate of the second product price class 7217, and the arrival rate of the third product price class 7218 are used to describe the arrival behavior of non-homogeneous Poisson random arrival processes.

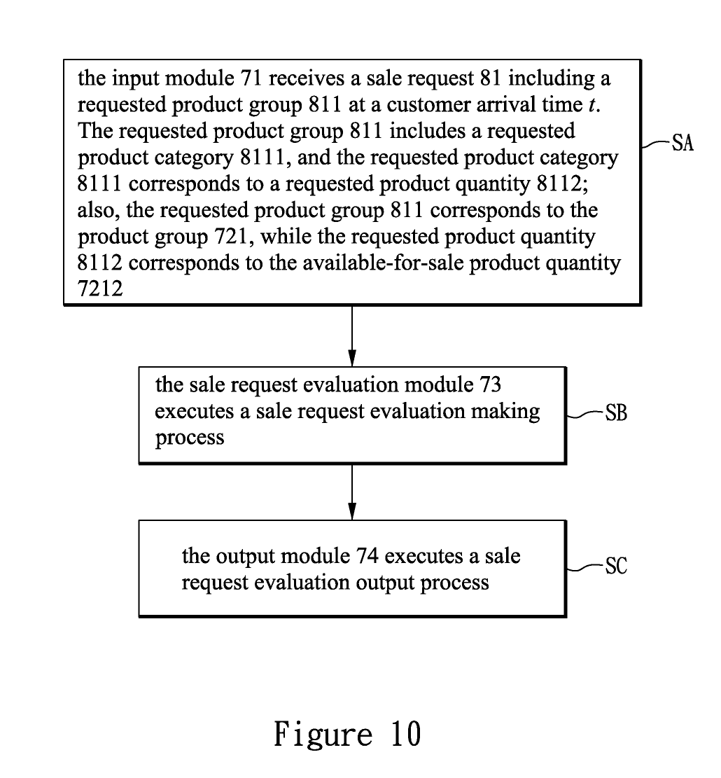

Please refer to FIGS. 7, 8, 9 and 10. FIG. 9 is a perspective view of a sale request, and FIG. 10 is the flowchart showing the sale request evaluation method of the third embodiment of the presented invention.

The sale request evaluation method of the third embodiment of the presented invention comprises the following steps:

Step SA: the input module 71 receives a sale request 81 including a requested product group 811 at a customer arrival time t. The requested product group 811 includes a requested product category 8111, and the requested product category 8111 corresponds to a requested product quantity 8112; also, the requested product group 811 corresponds to the product group 721, while the requested product quantity 8112 corresponds to the available-for-sale product quantity 7212;

Step SB: the sale request evaluation module 73 executes a sale request evaluation making process; and

Step SC: the output module 74 executes a sale request evaluation output process.

After the input module 71 receives the sale request 81 at a customer arrival time t, the sale request evaluation module 73 executes the sale request evaluation making process of the step SB to compute a set of possible requested quantities of the aforementioned three product price classes (U₁, U₂, and U₃) arriving from the customer arrival time t into the future based on the arrival rates of the three product price classes (i.e., the arrival rate of the first product price class 7216, the arrival rate of the second product price class 7217, and the arrival rate of the third product price class 7218). The sale request evaluation module 73 then creates a scenario tree having at least one level and consisting of a plurality of scenarios by using the sets of possible requested quantities of the aforementioned three product price classes U₁, U₂, and U₃. The sale request evaluation module 73 then computes a probability of each of the plurality of scenarios.

Then, under the condition of knowing the perfect information of each of the plurality of scenarios and refusing the sale request 81, the sale request evaluation module 73 computes the optimal revenue. Then, the sale request evaluation module 73 multiplies the optimal revenue in each of the plurality of scenarios with the corresponding probability to obtain the expected revenue of each of the plurality of scenarios. The sale request evaluation module 73 then sums up the expected revenue of each of the plurality of scenarios to obtain a first total expected revenue E(Rₜ(S)|D=DUPI).

Additionally, under the condition of knowing the perfect information of each of the plurality of scenarios and agreeing the sale request 81, the sale request evaluation module 73 computes the optimal revenue. Then, the sale request evaluation module 73 multiplies the optimal revenue in each of the plurality of scenarios with the corresponding probability to obtain the expected revenue of each of the plurality of scenarios. The sale request evaluation module 73 then sums up the expected revenue of each of the plurality of scenarios to obtain a second total expected revenue E(Rₜ(S−X)|D=DUPI).

Then, the sale request evaluation module 73 computes a gap between the two total expected revenues E(Gₜ(S,X)|D=ERG) based on the first total expected revenue E(Rₜ(S)|D=DUPI) and the second total expected revenue E(Rₜ(S−X)|D=DUPI). The quotation of price (not shown in the figure) is set to be not smaller than the gap between the two total expected revenues E(Gₜ(S,X)|D=ERG).

At last, in the sale request evaluation output process of the step SC, the output module 74 receives the quotation of price (not shown in the figure) to output a quotation-of-price signal (not shown in the figure). In the presented embodiment, the output module 74 can output the quotation-of-price signal (not shown in the figure) to the display module 75 or an Internet auction server (not shown in the figure), as the reference for a customer service agent or the aforementioned Internet auction server (not shown in the figure) in response to the sale request 81 by a customer, such as providing a quotation of price to the customer.

Hereinafter, the sale request evaluation method according to the third embodiment of the presented invention will be detailed described by using an example.

Initially, in the presented embodiment, the aforementioned sale request evaluation system is a quotation generating system, wherein the sale request arrival processes of the aforementioned three product price classes (the first product price class 7213, the second product price class 7214, and the third product price class 7215) are non-homogeneous Poisson random arrival processes. In other examples, the sale request arrival processes of the aforementioned three product price classes can also be other stochastic arrival processes with known probability descriptions.

In this example, the price of the first product price class 7213 is $300, that of the second product price class 7214 is $200, and that of the third product price class 7215 is $100. Also, the available-for-sale product quantity 7212 is 10. In this example, the sale period is divided into 4 sub-periods. The first three sub-periods have length of 5 days; that is, the first three sub-periods is in the duration of the 1^{st} day to the 15^{th} day. The 4^{th} sub-period starts from the 16^{th} day into the future.

In this example, the arrival rate of the first product price class 7216 (represented by λ₁(t)), the arrival rate of the second product price class 7217 (represented by λ₂(t)), and the arrival rate of the third product price class 7218 (represented by λ₃(t)) are function of time. They are:

$${λ}_{1} ( t ) = \{ \begin{matrix}0.2 & if t ∈ [ 0 , 5 ) \\ 0.5 & if t ∈ [ 5 , 10 ) \\ 0.1 & if t ∈ [ 10 , 15 ) \\ 0.0 & if t > 15\end{matrix} \\ {λ}_{2} ( t ) = \{ \begin{matrix}0.6 & if t ∈ [ 0 , 5 ) \\ 0.4 & if t ∈ [ 5 , 10 ) \\ 0.2 & if t ∈ [ 10 , 15 ) \\ 0.0 & if t > 15\end{matrix} \\ {λ}_{3} ( t ) = \{ \begin{matrix}1.1 & if t ∈ [ 0 , 5 ) \\ 0.5 & if t ∈ [ 5 , 10 ) \\ 0.0 & if t ∈ [ 10 , 15 ) \\ 0.0 & if t > 15\end{matrix}$$

Wherein, t∈[0,5) represents the 5-day sub-period starting from the 1^{st} day to the 5^{th} day, t∈(5,10] represents the 5-day sub-period starting from the 6^{th} day to the 10^{th} day, t∈(10,15] represents the 5-days sub-period starting from the 11^{th} day to the 15^{th} day, and t>15 represents the sub-period starting from the 16^{th} day into the future.

In the presented example, in the sale request 81 received by the input module 71, the requested product group 811 includes only one requested product category 8111. That is, the requested product quantity 8112 of the requested product category 8111 is 1, which implies that only one piece of clothes is requested for sale at a time.

The number of the sale request 81, the customer arrival time t, the gap between the two total expected revenues, and the quotation of price (not smaller than the gap between the two total expected revenue) are listed in Table 3.

TABLE 3

| | | | | | Gap | |
|---|---|---|---|---|---|---|
| | | | | | between | |
| No. of | | | | | the | |
| the | Customer | | | | two total | quotation |
| sale | arrival | | | | expected | of |
| request | time | n₁ₜ | n₂ₜ | n₃ₜ | revenue | price |
| 1 | 0.3245 | 3.9351 | 5.8053 | 7.643 | 149.5 | 150 |
| 2 | 0.9564 | 3.8087 | 5.4262 | 6.948 | 140.98 | 160 |
| 3 | 1.3758 | 3.7248 | 5.1745 | 6.4866 | 134.6 | 140 |
| 4 | 2.9578 | 3.4084 | 4.2253 | 4.7464 | 144.4 | 150 |
| 5 | 3.3145 | 3.3371 | 4.0113 | 4.3541 | 160.03 | 170 |

As shown in Table 3, as the customer arrival time t=0.3245, the input module 71 receives a sale request 81 (No. 1) (step SA).

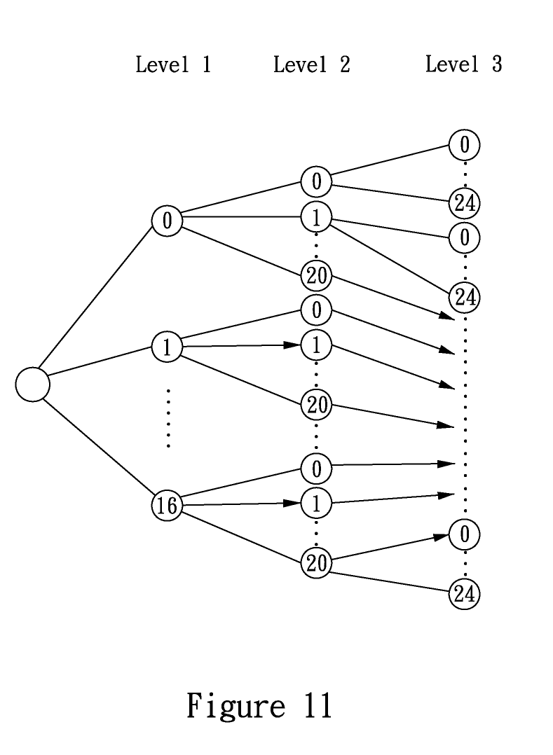

Then, the sale request evaluation module 73 determines whether the requested product quantity 8112 is not larger than the available-for-sale product quantity 7212. At this time, since the requested product quantity 8112 is not larger than the available-for-sale product quantity 7212 (1<10), the sale request evaluation module 73 computes the set of possible requested quantities of the aforementioned three product price classes (U₁, U₂ and U₃) to create a scenario tree having at least one level. The scenario tree consists of a plurality of scenarios as shown in FIG. 11.

The number of the levels of the scenario tree is equal to the number of the at least one product price class (i.e. the first product price class 7213, the second product price class 7214, and the third product price class 7215). The number of the plurality of scenario is the product of the number of the elements in the set of the first possible requested quantities U₁, the number of the elements in the set of the second possible requested quantities U₂, and the number of the elements in the set of the third possible requested quantities U₃.

In this example, the number of the levels of the scenario tree is 3, the number of scenarios of the scenario tree equals to the product of the number of elements in U₁, the number of elements in U₂, and the number of elements in U₃.

The computation of the set of the first possible requested quantities U₁, the set of the second possible requested quantities U₂, and the set of the third possible requested quantities U₃ are described as follows.

The sale request evaluation module 73 creates the scenario tree in FIG. 11 with the arrival rate of the first product price class 7216 (represented by λ₁(t)), the arrival rate of the second product price class 7217 (represented by λ₂(t)), the arrival rate of the third product price class 7218 (represented by λ₃(t)), and the customer arrival time t.

As the arrival number of the first product price class 7213 N₁ₜ, the arrival number of the second product price class 7214 N₂ₜ, and the arrival number of the third product price class 7215 N₃ₜ are Poisson random variables, their expected values are n₁ₜ, n₂ₜ, and n₃ₜ and can be computed by:

n₁ₜ=0.2×(5−0.3245)+0.5×5+0.1×0.5=3.9351

n₂ₜ=0.6×(5−0.3245)+0.4×5+0.2×5=5.8053

n₃ₜ=1.1×(5−0.3245)+0.5×5=7.643

It should be noted that, to simplify the computation, if the probability of any of the plurality of scenarios of the scenario tree in FIG. 11 is close to zero, for instance, being smaller than 10⁻⁶, the probability of the scenario is set at zero during the computation of the first total expected revenue or the computation of the second total expected revenue.

As a result, the set of first possible requested quantities U₁, the set of the second possible requested quantities U₂, and the set of the third possible requested quantities U₃ are:

$$\begin{matrix}{U}_{1} = \{ x \vert P ( {N}_{1 t} = x ) = \frac{{{e}^{- 3.9351} ( 3.9351 )}^{x}}{x !} > {10}^{- 6} \} \\ = \{ 0 , 1 , 2 , … , 16 \}\end{matrix}$$

$$\begin{matrix}{U}_{2} = \{ x \vert P ( {N}_{2 t} = x ) = \frac{{{e}^{- 5.8053} ( 5.8053 )}^{x}}{x !} > {10}^{- 6} \} \\ = \{ 0 , 1 , 2 , … , 20 \}\end{matrix}$$

$$\begin{matrix}{U}_{3} = \{ x \vert P ( {N}_{3 t} = x ) = \frac{{{e}^{- 7.643} ( 7.643 )}^{x}}{x !} > {10}^{- 6} \} \\ = \{ 0 , 1 , 2 , … , 24 \}\end{matrix}$$

Once the set of the first possible requested quantities U₁, the set of the second possible requested quantities U₂ and the set of the third possible requested quantities U₃ are obtained, the scenario tree in FIG. 11 can be created by the sale request evaluation module 73.

After the scenario tree is created, the sale request evaluation module 73 computes the probability corresponding to each of the plurality of scenario of the scenario tree. Then, under the condition of knowing the perfect information of each of the plurality of scenarios and refusing the sale request 81, the sale request evaluation module 73 computes the optimal revenue obtained in each of the plurality of scenario by considering each of the plurality of scenario. As in the state of perfect information, each of the products for sale is sold at the highest selling price in each of the scenario, to obtain the optimal revenue. The sale request evaluation module 73 multiplies the optimal revenue obtained in each of the plurality of scenario with the corresponding probability to obtain the expected revenue of each of the plurality of scenario. The sale request evaluation module 73 then sums up the expected revenue of each of the plurality of scenario to obtain a first total expected revenue E(Rₜ(S)|D=DUPI). After considering all of the plurality of scenario of the scenario tree under the condition of knowing the perfect information of each of the plurality of scenarios and refusing the sale request 81, the first total expected revenue E(Rₜ(S)|D=DUPI) obtained is $2251.88.

In addition, under the condition of knowing the perfect information of each of the plurality of scenarios and agreeing the sale request 81, the sale request evaluation module 73 computes the optimal revenue obtained in each of the plurality of scenario by considering each of the plurality of scenario, and then multiplies the optimal revenue obtained in each of the plurality of scenario with the corresponding probability to obtain the expected revenue of each of the plurality of scenario. The sale request evaluation module 73 then sums up the expected revenue of each of the plurality of scenario to obtain a second total expected revenue E(Rₜ(S−X)|D=DUPI). After considering all of the plurality of scenario of the scenario tree under the condition of knowing the perfect information of each of the plurality of scenarios and agreeing the sale request 81, the second total expected revenue E(Rₜ(S−X)|D=DUPI) obtained is $2102.38. As a result, the gap between the two total expected revenues E(Gₜ(S,X)|D=ERG) is $149.5.

Then, the sale request evaluation module 73 sets the quotation of price (not shown in the figure) to be not smaller than the gap between the two total expected revenues, for instance, $150. The sale request evaluation module 73 outputs the quotation of price to the output module 74. The output module 74 outputs the quotation-of-price signal (not shown in the figure) correspondingly to the display module 75 or an Internet auction server (not shown in the figure) to be used as a reference for a customer service agent or the aforementioned Internet auction server (not shown in the figure) in response to the sale request 81 by a customer.

Later, when the customer arrival time t=0.9564, the input module 71 receives a sale request 81 (No. 2). The sale request evaluation system then uses the sale request evaluation method of the third embodiment of the presented invention computes another gap between the two total expected revenues E(Gₜ(S,X)|D=ERG) having the value of $140.98.

Again, the sale request evaluation module 73 sets the quotation of price (not shown in the figure) to be not smaller than the gap between the two total expected revenues, for instance, $160. The sale request evaluation module 73 outputs the quotation of price to the output module 74. The output module 74 outputs the quotation-of-price signal (not shown in the figure) to the display module 75 or an Internet auction server (not shown in the figure), as a reference for a customer service agent or the aforementioned Internet auction server (not shown in the figure) in response to the sale request 81 by a customer.

Since the sale decision system of the sale decision method in the fourth embodiment of the presented invention is the same as the sale decision system of the sale decision method in the first embodiment of the presented invention, the detailed descriptions on the sale decision system is similar to previous ones.

Being similar to the sale decision system of the first embodiment, a product group is stored in the database module of the aforementioned sale decision system. Also, the product group includes a first product category (for example, economy-class of the flight), wherein the first product category corresponds to an available-for-sale product quantity. Moreover, the product group corresponds to a first product price class, a second product price class, and a third product price class. The first product price class corresponds to the arrival rate of the first product price class, the second product price class corresponds to the arrival rate of the second product price class, and the third product price class corresponds to the arrival rate of the third product price class.

Additionally, the price of the first product price class is higher than that of the second product price class and the price of the second product price class is higher than that of the third product price class. Moreover, the arrival rate of the first product price class, the arrival rate of the second product price class, and the arrival rate of the third product price class are used to describe the arrival behavior of the non-homogeneous Poisson random arrival process.

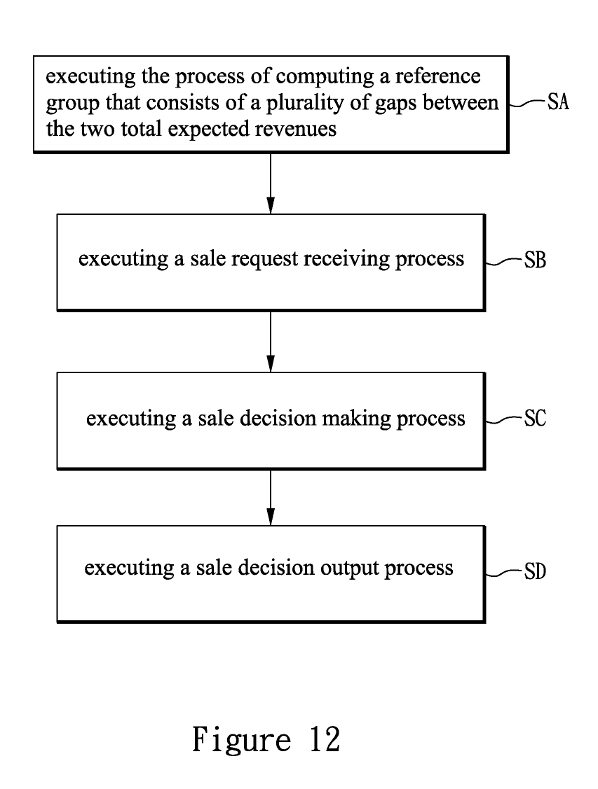

FIG. 12 shows the flowchart of the sale decision method of the fourth embodiment of the presented invention.

The sale decision method of the fourth embodiment of the presented invention comprises the following steps:

Step SA: executing the process of computing a reference group that consists of a plurality of gaps between the two total expected revenues;

Step SB: executing a sale request receiving process;

Step SC: executing a sale decision making process; and

Step SD: executing a sale decision output process.

At a recomputing time, in Step SA, the decision computation module of the sale decision system generates the reference group consisting of the plurality of gaps between the two total expected revenues. Also, the duration between the current time and the recomputing time is defined as the usage period of a reference group consisting of a plurality of gaps between the two total expected revenues, and the duration from the midpoint of the usage period of the reference group consisting of a plurality of gaps between the two total expected revenues into the future is defined as a customer arrival period.

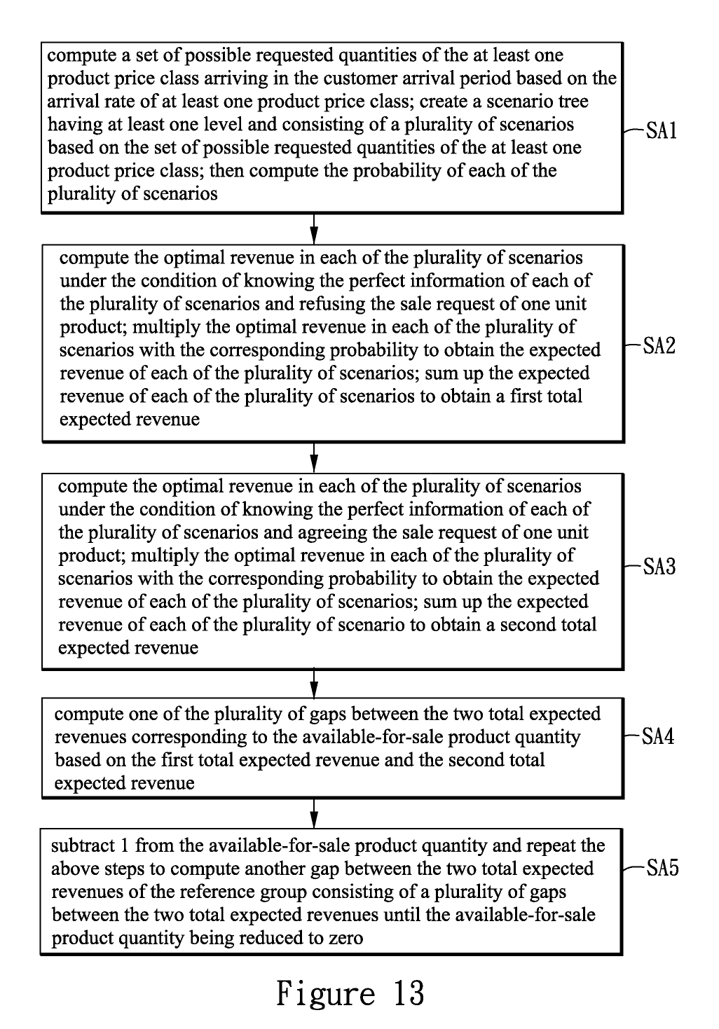

As shown in FIG. 13, the decision computation module executes the following steps repeatedly to compute the plurality of gaps between the two total expected revenues.

Step SA1: compute a set of possible requested quantities of the at least one product price class arriving in the customer arrival period based on the arrival rate of at least one product price class; create a scenario tree having at least one level and consisting of a plurality of scenarios based on the set of possible requested quantities of the at least one product price class; then compute the probability of each of the plurality of scenarios;

Step SA2: compute the optimal revenue in each of the plurality of scenarios under the condition of knowing the perfect information of each of the plurality of scenarios and refusing the sale request of one unit product; multiply the optimal revenue in each of the plurality of scenarios with the corresponding probability to obtain the expected revenue of each of the plurality of scenarios; sum up the expected revenue of each of the plurality of scenarios to obtain a first total expected revenue;

Step SA3: compute the optimal revenue in each of the plurality of scenarios under the condition of knowing the perfect information of each of the plurality of scenarios and agreeing the sale request of one unit product; multiply the optimal revenue in each of the plurality of scenarios with the corresponding probability to obtain the expected revenue of each of the plurality of scenarios; sum up the expected revenue of each of the plurality of scenario to obtain a second total expected revenue;

Step SA4: compute one of the plurality of gaps between the two total expected revenues corresponding to the available-for-sale product quantity based on the first total expected revenue and the second total expected revenue; and

Step SA5: subtract 1 from the available-for-sale product quantity and repeat the above steps to compute another gap between the two total expected revenues of the reference group consisting of a plurality of gaps between the two total expected revenues until the available-for-sale product quantity being reduced to zero.

Thus, the reference group consisting of the plurality of gaps between the two total expected revenues is generated.

The computation process to generate the reference group consisting of a plurality of gaps between the two total expected revenues will be detailed described by an example.

In the presented embodiment, the aforementioned sale decision system is assumed to be a flight booking system, wherein the first product price class, the second product price class, and the third product price class corresponds to a first booking price class, a second booking price class, and a third booking price class, respectively. Also, the sale request arrival process of the aforementioned three product price classes (i.e. the first product price class, the second product price class, and the third product price class) are non-homogeneous Poisson random arrival process. In other examples, the sale request arrival processes of the aforementioned three product price classes can also be other stochastic arrival processes with known probability descriptions.

In this example, the price of the first product price class is $300, that of the second product price class is $200, and that of the third product price class is $100. In addition, the available-for-sale product quantity is 10. In this flight booking system, the sale period (i.e., the booking horizon) is set to be 10 days before the departure time of the flight. The 10-days sale period is further divided into two 5-day sub-periods. Moreover, the aforementioned current time is set to be zero (i.e. the start time of the 1^{st} day, which is also 10 days before the departure time of the flight). The recomputing time is set to be the end time of the 1^{st} day. The usage period of the reference group consisting of a plurality of gaps between the two total expected revenues is set to be the duration between the current time and the end of the 1^{st} day (i.e., the recomputing time). That is, the usage period of the reference group consisting of a plurality of gaps between the two total expected revenues is [0,1]. The customer arrival period is set to be the duration from the midpoint of usage period of the reference group consisting of a plurality of gaps between the two total expected revenues into the future; that is, the customer arrival period is [0.5,10].

It should be noted that the aforementioned “recomputing time” and the length of the “usage period of the reference group consisting of a plurality of gaps between the two total expected revenues” are determined by the computer computation speed, network flow loading, or the data transfer rates of hard drives. The “the usage period of a reference group consisting of a plurality of gaps between the two total expected revenues” is not necessary to be a 1-day duration; it can also be a 4-hours duration, or a shorter duration. The decision computation module of the sale decision system can also compute another reference group consisting of a plurality of gaps between the two total expected revenues once the computer of the sale decision system is in an idle status for the decision making process in usage periods of the next reference group consisting of a plurality of gaps between the two total expected revenue.

In this example, the arrival rate of the first product price class (represented by λ₁(t)), the arrival rate of the second product price class (represented by λ₂(t)), and the arrival rate of the third product price class (represented by λ₃(t)) are all function of time. They are:

$${λ}_{1} ( t ) = \{ \begin{matrix}0.2 & if t ∈ [ 0 , 5 ) \\ 0.6 & if t ∈ ( 5 , 10 ]\end{matrix} \\ {λ}_{2} ( t ) = \{ \begin{matrix}0.6 & if t ∈ [ 0 , 5 ) \\ 0.6 & if t ∈ ( 5 , 10 ]\end{matrix} \\ {λ}_{3} ( t ) = \{ \begin{matrix}1.1 & if t ∈ [ 0 , 5 ) \\ 0.5 & if t ∈ ( 5 , 10 ]\end{matrix}$$

Wherein, t∈[0,5) represents the 5-day sub-period starting from 10 days before the departure time of the flight to 6 days before the departure time of the flight. t∈(5,10] represents the 5-day sub-period starting from 5 days before the departure time to the departure time of the flight.

Since the “usage period of a reference group consisting of a plurality of gaps between the two total expected revenues is set to be the duration between 10 days before the departure time to 9 days before the departure time of the flight (i.e., t∈[0,1)), the decision computation module of the sale decision system computes the sets of possible requested quantities of the at least one product price class arriving in the customer arrival period (i.e., t∈[0.5,∞)). Thus, the decision computation module of the sale decision system creates a scenario tree having three levels and consisting of a plurality of scenarios. The probability of each of the plurality of scenarios is computed. Since the computation of the first total expected revenue and the second total expected revenue (i.e. the step SA2 and the step SA3) have been described in the first embodiment of the present invention, detailed description of the computation is omitted.

Then, in step SA4, the decision computation module of the sale decision system computes one of the plurality of gaps between the two total expected revenues corresponding to the available-for-sale product quantity based on the first total expected revenue obtained in the step SA2 and the second total expected revenue obtained in the step SA3.

In the step SA5, the decision computation module of the sale decision system subtracts 1 from the available-for-sale product quantity (for example, subtracting 1 from 10), and repeats the above steps, until the available-for-sale product quantity being reduced to zero. In this manner, the value of the other gaps between the two total expected revenues of the reference group consisting of a plurality of gaps between the two total expected revenues are obtained.

Thus, the decision computation module of the sale decision system computes the value of the 10 gaps between the two total expected revenues of the reference group consisting of a plurality of gaps between the two total expected revenues (since the available-for-sale product quantity is 10 in this example), as listed in Table 4.

TABLE 4

| Available-for-sale product | Gap between the two total |
|---|---|
| quantity | expected revenues |
| 10 | 147.2494 |
| 9 | 162.6619 |
| 8 | 178.1652 |
| 7 | 194.1032 |
| 6 | 211.4942 |
| 5 | 231.3636 |
| 4 | 253.2868 |
| 3 | 274.3015 |
| 2 | 290.0087 |
| 1 | 297.9685 |

Then, in the sale request receiving process of the step SB, the input module of the sale decision system receives a sale request including a requested product group at a customer arrival time t, wherein the requested product group includes only one requested product category (i.e., economy-class of the flight). Also, the requested product quantity of the requested product category is 1; that is, only one seat is requested for sale at a time. It should be noted that, in the presented embodiment, the customer arrival time t is in the “usage period of the reference group consisting of a plurality of gaps between the two total expected revenues” (i.e. t∈[0,1)).

Then, in the sale decision making process of the step SC, the decision computation module of the sale decision system computes and outputs an agree-to-sell decision or a refuse-to-sell decision, based on the request total prices and the 10 gaps between the two total expected revenues of the reference group consisting of a plurality of gaps between the two total expected revenues listed in Table 4.

For example, the first sale request arrives at time t=0.3245 with the request total price of $100. Since the request total price ($100) is smaller than the gap between the two total expected revenues corresponding to the available-for-sale product quantity of 10 ($147.2494), the decision computation module of the sale decision system outputs the refuse-to-sell decision.

When the second sale request arrives at time t=0.3458 with the request total price of $300. Since the request total price ($300) is greater than the gap between the two total expected revenues corresponding to the available-for-sale product quantity of 10 ($147.2494), the decision computation module of the sale decision system outputs the agree-to-sell decision.

After a certain amount of time, as the third sale request arrives at time t=0.8554, with the request total price of $200. Since the request total price ($200) is greater than the gap between the two total expected revenues corresponding to the available-for-sale product quantity of 9 ($162.6619), the decision computation module of the sale decision system outputs the agree-to-sell decision.

It should be noted that, the decision computation module would compute the plurality of gaps between the two total expected revenues of another reference group consisting of a plurality of gaps between the two total expected revenues at a “recomputing time”. In this example, the “recomputing time” is set to be the end time of the 1^{st} day, when the decision making process will be computed for the usage period of the next reference group consisting of a plurality of gaps between the two total expected revenues.

Finally, in the sale decision output process of the step SD, the output module of the sale decision system receives the agree-to-sell decision (not shown in the figure) or the refuse-to-sell decision (not shown in the figure) to output an agree-to-sell signal (not shown in the figure) or a refuse-to-sell signal (not shown in the figure) correspondingly. In the presented embodiment, the output module can output the agree-to-sell signal (not shown in the figure) or the refuse-to-sell signal (not shown in the figure) to the display module or an Internet booking server (not shown in the figure), as the reference for a customer service agent or the aforementioned Internet booking server (not shown in the figure) in response to the sale request by a customer.

As described above, by applying the sale decision method on a sale decision system, once the input module of the sale decision system receives a sale request, the decision computation module of the sale decision system can make a decision (agree-to-sell decision or refuse-to-sell decision) in response to this sale request promptly. The output module of the sale decision system then outputs the signal (agree-to-sell signal or refuse-to-sell signal) correspondingly to a display module or an Internet booking server, as the reference for a customer service agent or the aforementioned Internet booking server in response to the sale request by a customer. Moreover, since the decision computation module of the sale decision system makes use of the mathematical tools such as non-homogeneous Poisson random arrival process, the Poisson distribution function (or other stochastic arrival processes with known probability descriptions), scenario tree, and the decision model using perfect information, the sale decision method of the presented invention can increase the expected revenue by selling available products. Since the computation of the sale decision method of the presented invention is simple, the time required for making a sale decision is short.

In addition, since in the sale request evaluation system applying the sale request evaluation, after the input module thereof receives a sale request, the sale request evaluation module thereof can compute a gap between the two total expected revenues and set a quotation of price to be not smaller than the gap between the two total expected revenues promptly. Then, the output module thereof outputs the quotation-of-price signal to a display module or an Internet booking server, as the reference for a customer service agent or the aforementioned Internet booking server in response to the sale request by a customer. Moreover, since the sale request evaluation module of the sale request evaluation system makes use of the mathematical tools such as non-homogeneous Poisson random arrival process, the Poisson distribution function (or other stochastic arrival processes with known probability descriptions) the scenario tree, and the decision model using perfect information, the sale request evaluation method of the presented invention can increase the revenue by selling available products. Since the computation of the sale request evaluation method of the presented invention is simple, the time required for generating a quotation of price is short.

Although the presented invention has been explained in relation to its preferred embodiment, it is to be understood that many other possible modifications and variations can be made without departing from the spirit and scope of the invention as herein claimed.

What is claimed is:

1. A sale decision method, being applied in a sale decision system including an input module, a database module, a decision computation module, and an output module, wherein at least one product group is stored in the database module, the decision computation module is coupled with the input module and the database module, respectively; the output module is coupled with the decision computation module, and the sale decision method comprises the following steps:
executing a sale request receiving process;
executing a sale decision making process; and
executing a sale decision output process;
at a customer arrival time, the input module in the sale request receiving process receives a sale request involving a requested product group and a request total price, the requested product group includes at least one requested product category, and the at least one requested product category corresponds to a requested product quantity;
wherein, in the sale decision making process, the decision computation module computes and outputs an agree-to-sell decision or a refuse-to-sell decision, the output module receives the agree-to-sell decision or the refuse-to-sell decision from the sale decision output process to output an agree-to-sell signal or a refuse-to-sell signal;
wherein, the at least one product group includes at least one product category, and the at least one product category corresponds to an available-for-sale product quantity; the at least one product group corresponds to at least one product price class, the at least one product price class corresponds to the arrival rate of a product price class; the at least one requested product group corresponds to the at least one product group, the requested product quantity corresponds to the available-for-sale product quantity;
in addition, when the input module receives the sale request at the customer arrival time, the decision computation module executes the sale decision making process to compute a set of possible requested quantities of the at least one product price class arriving from the arrival time of the customer into the future based on the arrival rates of product price classes; the decision computation module then creates a scenario tree having at least one level and consisting of a plurality of scenarios based on the sets of possible requested quantities of the at least one product price class; the decision computation module then computes the probability of each of the plurality of scenarios;
then, under the condition of knowing the perfect information of each of the plurality of scenarios and refusing the sale request, the decision computation module computes the optimal revenue in each of the plurality of scenarios by considering each of the plurality of scenarios, and then multiplies the optimal revenue obtained in each of the plurality of scenarios with the probability thereof to obtain the expected revenue of each of the plurality of scenarios; the decision computation module sums up the expected revenue of each of the plurality of scenarios to obtain a first total expected revenue;
under the condition of knowing the perfect information of each of the plurality of scenarios and agreeing the sale request, the decision computation module computes the optimal revenue in each of the plurality of scenarios by considering each of the plurality of scenarios, and then multiplies the optimal revenue obtained in each of the plurality of scenarios with the probability thereof to obtain the expected revenue of each of the plurality of scenarios; the decision computation module sums up the expected revenue of each of the plurality of scenarios to obtain a second total expected revenue;
the decision computation module computes a gap between the two total expected revenues based on the first total expected revenue and the second total expected revenue; the decision computation module then compares the gap between the two total expected revenues with the request total price; if the gap between the two total expected revenues is greater than the request total price, the decision computation module outputs the refuse-to-sell decision to the output module; if the gap between the two total expected revenues is not greater than the request total price, the decision computation module outputs the agree-to-sell decision to the output module, and the decision computation module subtracts the requested product quantity from the available-for-sale product quantity.

2. The sale decision method as claimed in claim 1, wherein the at least one product group includes a first product category, the first product category corresponds to a first available-for-sale product quantity; the first product group corresponds to a first product price class, a second product price class, and a third product price class; the first product price class corresponds to the arrival rate of the first product price class, the second product price class corresponds to the arrival rate of the second product price class, and the third product price class corresponds to the arrival rate of the third product price class; the price of the first product price class is higher than that of the second product price class, and the price of the second product price class is higher than that of the third product price class.

3. The sale decision method as claimed in claim 2, wherein the first product price class, the second product price class and the third product price class correspond to a first booking price class, a second booking price class, and a third booking price class, respectively.

4. The sale decision method as claimed in claim 2, wherein the customer arrival time is in a sale period.

5. The sale decision method as claimed in claim 1, wherein the sale request arrival process of the at least one product price class is a non-homogeneous Poisson random arrival process or other stochastic arrival processes with known probability descriptions.

6. The sale decision method as claimed in claim 1, wherein the number of the levels of the scenario tree is equal to the number of the at least one product price class.

7. The sale decision method as claimed in claim 2, wherein the decision computation module determines whether the requested product quantity is not larger than the available-for-sale product quantity before computing the set of possible requested quantities of the at least one product price class, and if the requested product quantity is larger than the available-for-sale product quantity, the decision computation module outputs the refuse-to-sell decision to the output module.

8. The sale decision method as claimed in claim 7, after the decision computation module determines that the requested product quantity is not larger than the available-for-sale product quantity, the decision computation module determines whether the request product price class of all the requested product group corresponds to the first product price class, and when the request product price classes corresponds to the first product price classes, the decision computation module outputs the agree-to-sell decision to the output module and subtracts the requested product quantity from the available-for-sale product quantity.

9. The sale decision method as claimed in claim 1, if the probability of any of the plurality of scenarios is close to zero, for instance, being smaller than 10⁻⁶, the probability of the scenario of the plurality of scenarios is set to be zero during the computation process of the first total expected revenue or the computation process of the second total expected revenue.

10. The sale decision method as claimed in claim 1, wherein the at least one product price class corresponds to a canceling probability of a product price class; the decision computation module computes the set of possible actual requested quantities of the at least one product price class arriving from the arrival time of the customer into the future based on both of the arrival rate of a product price class and the canceling probability of the product price class.

11. A sale request evaluation method, being applied in a sale request evaluation system including an input module, a database module, a sale request evaluation module, and an output module, wherein at least one product group is stored in the database module, the sale request evaluation module is coupled with the input module and the database module, respectively; the output module is coupled with the sale request evaluation module, and the sale request evaluation method comprises the following steps:
executing a sale request evaluation process;
executing a sale request evaluation making process; and
executing a sale request evaluation output process;
at a customer arrival time, the input module in the sale request evaluation process receives a sale request involving at least one requested product group, the at least one requested product group includes at least one requested product category and the at least one requested product category corresponds to a requested product quantity; in the sale request evaluation making process, the sale request evaluation module computes and outputs a quotation of price, the output module receives the quotation of price from the sale request evaluation output process to output a quotation-of-price signal;
wherein, the at least one product group includes at least one product category, and the at least one product category corresponds to an available-for-sale product quantity; the at least one product group corresponds to at least one product price class, the at least one product price class corresponds to the arrival rate of a product price class; the at least one requested product group corresponds to the at least one product group, the requested product quantity corresponds to the available-for-sale product quantity;
in addition, when the input module receives the sale request at the customer arrival time, the sale request evaluation module executes the sale request evaluation making process to compute the set of possible requested quantities of the at least one product price class arriving from the arrival time of the customer into the future based on the arrival rates of product price classes; the sale request evaluation module then creates a scenario tree having at least one level and consisting of a plurality of scenarios based on the sets of possible requested quantities of the at least one product price class, the sale request evaluation module then computes the probability of each of the plurality of scenarios;
then, under the condition of knowing the perfect information of each of the plurality of scenarios and refusing the sale request, the sale request evaluation module computes the optimal revenue in each of the plurality of scenarios by considering each of the plurality of scenarios, and then multiplies the optimal revenue obtained in each of the plurality of scenarios with the probability thereof to obtain the expected revenue of each of the plurality of scenarios; the sale request evaluation module sums up the expected revenue of each of the plurality of scenarios to obtain a first total expected revenue;
under the condition of knowing the perfect information of each of the plurality of scenarios and agreeing the sale request, the sale request evaluation module computes the optimal revenue in each of the plurality of scenarios by considering each of the plurality of scenarios, and then multiplies the optimal revenue obtained in each of the plurality of scenarios with the probability thereof to obtain the expected revenue of each of the plurality of scenarios; the sale request evaluation module sums up the expected revenue of each of the plurality of scenarios to obtain a second total expected revenue;
the sale request evaluation module computes a gap between the two total expected revenues based on the first total expected revenue and the second total expected revenue; wherein the quotation of price is not smaller than the gap between the two total expected revenues.

12. The sale request evaluation method as claimed in claim 11, wherein the at least one product group includes a first product category, the first product category corresponds to a first available-for-sale product quantity; the first product group corresponds to a first product price class, a second product price class, and a third product price class; the first product price class corresponds to the arrival rate of the first product price class, the second product price class corresponds to the arrival rate of the second product price class, and the third product price class corresponds to the arrival rate of the third product price class; the price of the first product price class is higher than that of the second product price class, and the price of the second product price class is higher than that of the third product price class.

13. The sale request evaluation method as claimed in claim 11, wherein the sale request arrival process of the at least one product price class is a non-homogeneous Poisson random arrival process or other stochastic arrival processes with known probability descriptions.

14. The sale request evaluation method as claimed in claim 11, wherein the number of the levels of the scenario tree is equal to the number of the at least one product price class.

15. The sale request evaluation method as claimed in claim 11, if the probability of any of the plurality of scenarios is close to zero, for instance, being smaller than 10⁻⁶, the probability of the scenario of the plurality of scenarios is set to be zero during the computation process of the first total expected revenue or the computation process of the second total expected revenue.

16. A sale decision method, being applied in a sale decision system including an input module, a database module, a decision computation module, and an output module, wherein at least one product group is stored in the database module, the decision computation module is coupled with the input module and the database module, respectively; the output module is coupled with the decision computation module, and the sale decision method comprises the following steps:
executing the computation process to generate a reference group consisting of a plurality of gaps between the two total expected revenues;
executing a sale request receiving process;
executing a sale decision making process; and
executing a sale decision output process;
wherein, the at least one product group includes at least one product category, and the at least one product category corresponds to an available-for-sale product quantity; the at least one product group corresponds to at least one product price class, the at least one product price class corresponds to the arrival rate of a product price class; the at least one requested product group corresponds to the at least one product group, the requested product quantity corresponds to the available-for-sale product quantity;
wherein, a reference group consists of a plurality of gaps between the two total expected revenues; and in the computing process to generate the reference group consisting of a plurality of gaps between the two total expected revenues, the decision computation module executes the following steps repeatedly at a recomputing time to compute the plurality of gaps between the two total expected revenues; the duration between the current time and the recomputing time is defined as a usage period of the reference group consisting of a plurality of gaps between the two total expected revenues, and the duration from the midpoint of the usage period of the reference group consisting of a plurality of gaps between the two total expected revenues into the future is defined as a customer arrival period;
computing sets of possible requested quantities of the at least one product price class arriving in the customer arrival period based on the arrival rates of product price classes; creating a scenario tree having at least one level and consisting of a plurality of scenarios based on the sets of possible requested quantities of the at least one product price class; then, computing the probability of each of the plurality of scenarios;
computing the optimal revenue in each of the plurality of scenarios by considering each of the plurality of scenarios under the condition of knowing the perfect information of each of the plurality of scenarios and refusing the sale request of one unit product; multiplying the optimal revenue obtained in each of the plurality of scenarios with the corresponding probability to obtain the expected revenue of each of the plurality of scenarios; summing up the expected revenue of each of the plurality of scenarios to obtain a first total expected revenue;
computing the optimal revenue in each of the plurality of scenarios by considering each of the plurality of scenarios under the condition of knowing the perfect information of each of the plurality of scenarios and agreeing the sale request of one unit product; multiplying the optimal revenue obtained in each of the plurality of scenarios with the corresponding probability to obtain the expected revenue of each of the plurality of scenarios; summing up the expected revenue of each of the plurality of scenarios to obtain a second total expected revenue;
computing one of the plurality of gaps between the two total expected revenues corresponding to the available-for-sale product quantity based on the first total expected revenue and the second total expected revenue; and
subtracting 1 from the available-for-sale product quantity, then, repeating the above steps to compute other gaps between the two total expected revenues of the reference group consisting of a plurality of gaps between the two total expected revenues until the available-for-sale product quantity is reduced to zero;
at a customer arrival time, the input module in the sale request evaluation process receives a sale request involving a requested product group and a request total price, the requested product group includes at least one requested product category and the at least one requested product category corresponds to a requested product quantity;
wherein, in the sale decision making process, the decision computation module computes and outputs an agree-to-sell decision or a refuse-to-sell decision based on the gap between the two total expected revenues corresponding to the current available-for-sale product quantity; if the gap between the two total expected revenues is greater than the request total price, the decision computation module outputs the refuse-to-sell decision to the output module; if the gap between the two total expected revenues is not greater than the request total price, the decision computation module outputs the agree-to-sell decision to the output module and the decision computation module subtracts the requested product quantity from the available-for-sale product quantity;
in the sale decision output process, the output module receives the agree-to-sell decision or the refuse-to-sell decision to output an agree-to-sell signal or a refuse-to-sell signal.

17. The sale decision method as claimed in claim 16, wherein the at least one product group includes a first product category, the first product category corresponds to a first available-for-sale product quantity; the first product group corresponds to a first product price class, a second product price class, and a third product price class; the first product price class corresponds to the arrival rate of the first product price class, the second product price class corresponds to the arrival rate of the second product price class, and the third product price class corresponds to the arrival rate of the third product price class; the price of the first product price class is higher than that of the second product price class, and the price of the second product price class is higher than that of the third product price class.

18. The sale decision method as claimed in claim 17, wherein the first product price class, the second product price class and the third product price class correspond to a first booking price class, a second booking price class, and a third booking price class, respectively.

19. The sale decision method as claimed in claim 16, wherein a customer arrival time is in the usage period of the reference group consisting of a plurality of gaps between the two total expected revenues.

20. The sale decision method as claimed in claim 16, wherein the sale request arrival process of the at least one product price class is a non-homogeneous Poisson random arrival process or other stochastic arrival processes with known probability descriptions.

21. The sale decision method as claimed in claim 16, wherein the decision computation module recomputes another reference group consisting of a plurality of gaps between the two total expected revenues when the time is at the next recomputing time.

22. The sale decision method as claimed in claim 16, wherein the decision computation module can compute another reference group consisting of a plurality of gaps between the two total expected revenues at an interval equal to the usage period of the reference group consisting of a plurality of gaps between the two total expected revenues.

23. The sale decision method as claimed in claim 16, wherein the recomputing frequencies of the reference group consisting of a plurality of gaps between the two total expected revenues is determined by the computer computation speed, network flow loading, or the data transfer rates of hard drives.
